(19) United States
(12) Patent Application Publication
(10) Pub. No.: US 2024/0414695 A1
(43) Pub. Date: Dec. 12, 2024

(54) COOPERATIVE PAGING AND WAKEUP SIGNALS FOR SIDELINK COMMUNICATIONS

(71) Applicant: QUALCOMM Incorporated, San Diego, CA (US)

(72) Inventors: Luanxia YANG, Beijing (CN); Jing SUN, San Diego, CA (US); Aleksandar DAMNJANOVIC, Del Mar, CA (US); Rajat PRAKASH, San Diego, CA (US); Xiaoxia ZHANG, San Diego, CA (US); Changlong XU, Beijing (CN); Tao LUO, San Diego, CA (US); Fang YUAN, Beijing (CN); Jelena DAMNJANOVIC, Del Mar, CA (US)

(21) Appl. No.: 18/718,506

(22) PCT Filed: Mar. 1, 2022
(86) PCT No.: PCT/CN2022/078542

§ 371 Date: Jun. 11, 2024

(51) Int. Cl. H04W 68/02; H04W 52/02; H04W 72/25

(52) U.S. Cl. CPC H04W 68/02; H04W 52/0229; H04W 72/25

(57) ABSTRACT

Wireless communications systems and methods related to communicating control information are provided. A method of wireless communication performed by a first sidelink user equipment (UE) may include receiving, from a second sidelink UE, a request to monitor for at least one of a paging signal associated with the second sidelink UE or a wakeup signal (WUS) associated with the second sidelink UE, monitoring for the at least one of the paging signal or the wakeup signal based on the request, receiving, from a base station (BS), the at least one of the paging signal or the wakeup signal, and transmitting, to the second sidelink UE, the at least one of the paging signal or the wakeup signal.

### TECHNICAL FIELD

This application relates to wireless communication systems, and more particularly, to configuring cooperative paging and wakeup signals for sidelink communications.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a first sidelink user equipment (UE) may include receiving, from a second sidelink UE, a request to monitor for at least one of a paging signal associated with the second sidelink UE or a wakeup signal (WUS) associated with the second sidelink UE; monitoring for the at least one of the paging signal or the wakeup signal based on the request; receiving, from a base station (BS), the at least one of the paging signal or the wakeup signal; and transmitting, to the second sidelink UE, the at least one of the paging signal or the wakeup signal.

In an additional aspect of the disclosure, a method of wireless communication performed by a base station (BS) may include receiving, from at least one of a first sidelink UE or a second sidelink UE, a request to receive via a sidelink communication from the first sidelink UE, at least one of a paging signal associated with the second sidelink UE or a wakeup signal associated with the second sidelink UE; and transmitting, to the first sidelink UE, the at least one of the paging signal associated with the second sidelink UE or the wakeup signal associated with the second sidelink UE.

In an additional aspect of the disclosure, a first sidelink user equipment (UE) may include a memory; a transceiver; and at least one processor coupled to the memory and the transceiver, wherein the first sidelink UE is configured to receive, from a second sidelink UE, a request to monitor for at least one of a paging signal associated with the second sidelink UE or a wakeup signal (WUS) associated with the second sidelink UE; monitor for the at least one of the paging signal or the wakeup signal based on the request; receive, from a base station (BS), the at least one of the paging signal or the wakeup signal; and transmit, to the second sidelink UE, the at least one of the paging signal or the wakeup signal.

In an additional aspect of the disclosure, a base station (BS) may include a memory; a transceiver; and at least one processor coupled to the memory and the transceiver, wherein the BS is configured to receive, from at least one of a first sidelink UE or a second sidelink UE, a request to receive via a sidelink communication from the first sidelink UE, at least one of a paging signal associated with the second sidelink UE or a wakeup signal associated with the second sidelink UE; and transmit, to the first sidelink UE, the at least one of the paging signal associated with the second sidelink UE or the wakeup signal associated with the second sidelink UE.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates a sidelink wireless communication network according to some aspects of the present disclosure.

FIGS. 3-5 illustrate paging monitoring occasions and WUS monitoring occasions according to some aspects of the present disclosure.

FIG. 6 is a signaling diagram of a wireless communication method according to some aspects of the present disclosure.

FIG. 7 is a signaling diagram of a wireless communication method according to some aspects of the present disclosure.

FIG. 8 is a block diagram of an exemplary user equipment (UE) according to some aspects of the present disclosure.

FIG. 9 is a block diagram of an exemplary base station (BS) according to some aspects of the present disclosure.

FIG. 10 is a flow diagram of a communication method according to some aspects of the present disclosure.

FIG. 11 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHZ, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about 70 percent (%).

Some sidelink systems may operate over a 20 MHz bandwidth in an unlicensed band. A BS may configure a sidelink resource pool over the 20 MHz band for sidelink communications. A sidelink resource pool is typically partitioned into multiple frequency subchannels or frequency subbands (e.g., about 5 MHz each) and a sidelink UE may select a sidelink resource (e.g., a subchannel) from the sidelink resource pool for sidelink communication. To satisfy an OCB of about 70%, a sidelink resource pool may utilize a frequency-interlaced structure. For instance, a frequency-interlaced-based sidelink resource pools may include a plurality of frequency interlaces over the 20 MHz band, where each frequency interlace may include a plurality of resource blocks (RBs) distributed over the 20 MHz band. For example, the plurality of RBs of a frequency interlace may be spaced apart from each other by one or more other RBs in the 20 MHz unlicensed band. A sidelink UE may select a sidelink resource in the form of frequency interlaces from the sidelink resource pool for sidelink communication. In other words, sidelink transmissions may utilize a frequency-interlaced waveform to satisfy an OCB of the unlicensed band. However, S-SSBs may be transmitted in a set of contiguous RBs, for example, in about eleven contiguous RBs. As such, S-SSB transmissions alone may not meet the OCB requirement of the unlicensed band. Accordingly, it may be desirable for a sidelink sync UE to multiplex an S-SSB transmission with one or more channel state information reference signals (CSI-RSs) in a slot configured for S-SSB transmission so that the sidelink sync UE's transmission in the slot may comply with an OCB requirement.

The present application describes mechanisms for a sidelink UE to multiplex an S-SSB transmission with a CSI-RS transmission in a frequency band to satisfy an OCB of the frequency band. For instance, the sidelink UE may determine a multiplex configuration for multiplexing a CSI-RS transmission with an S-SSB transmission in a sidelink BWP. The sidelink UE may transmit the S-SSB transmission in the sidelink BWP during a sidelink slot. The sidelink UE may transmit one or more CSI-RSs in the sidelink BWP during the sidelink slot by multiplexing the CSI-RS and the S-SSB transmission based on the multiplex configuration.

In some aspects, the sidelink UE may transmit the S-SSB transmission at an offset from a lowest frequency of the sidelink BWP based on a synchronization raster (e.g., an NR-U sync raster). In some aspects, the sidelink UE may transmit the S-SSB transmission aligned to a lowest frequency of the sidelink BWP. For instance, a sync raster can be defined for sidelink such that the S-SSB transmission may be aligned to a lowest frequency of the sidelink BWP.

In some aspects, the multiplex configuration includes a configuration for multiplexing the S-SSB transmission with a frequency interlaced waveform sidelink transmission to meet the OCB requirement. For instance, the sidelink transmission may include a CSI-RS transmission multiplexed in frequency within a frequency interlace with RBs spaced apart in the sidelink BWP. In some instances, the sidelink UE may rate-match the CSI-RS transmission around RBs that are at least partially overlapping with the S-SSB transmission.

In some aspects, the multiplex configuration includes a configuration for multiplexing the S-SSB transmission with a subchannel-based sidelink transmission to meet the OCB requirement. For instance, the sidelink transmission may include a CSI-RS transmission multiplexed in time within a subchannel including contiguous RBs in the sidelink BWP. For instance, the S-SSB transmission may be transmitted at a low frequency portion of the sidelink BWP, and the CSI-RS may be transmitted in a subchannel located at a high frequency portion of the sidelink BWP to meet the OCB.

In some aspects, a BS may configure different sidelink resource pools for slots that are associated with S-SSB transmissions and for slots that are not associated with S-SSB transmissions. For instance, the BS may configure a first resource pool with a frequency-interlaced structure for slots that are not configured for S-SSB transmissions. The first resource pool may include a plurality of frequency interlaces (e.g., distributed RBs), where each frequency interlace may carry a PSCCH/PSSCH transmission. The BS may configure a second resource pool with a subchannel-based structure for slots that are configured for S-SSB transmission. The second resource pool may include a plurality of frequency subchannels (e.g., contiguous RBs), where each subchannel may carry a PSCCH/PSSCH transmission. To satisfy an OCB in a sidelink slot configured for an S-SSB transmission, the sidelink UE (e.g., a sidelink sync UE) may transmit an S-SSB transmission multiplexed with a CSI-RS transmission. For instance, the S-SSB transmission may be transmitted in frequency resources located at a lower frequency portion of a sidelink BWP and the CSI-RS transmission may be transmitted in frequency resources located at higher frequency portion of the sidelink BWP.

Aspects of the present disclosure may provide several benefits. For example, providing additional opportunities for a sidelink sync UE to transmit S-SSBs may increase the number of UEs synchronized in the wireless network. Maintaining synchronization among the UEs in the sidelink wireless network may increase the reliability and throughput of the network.

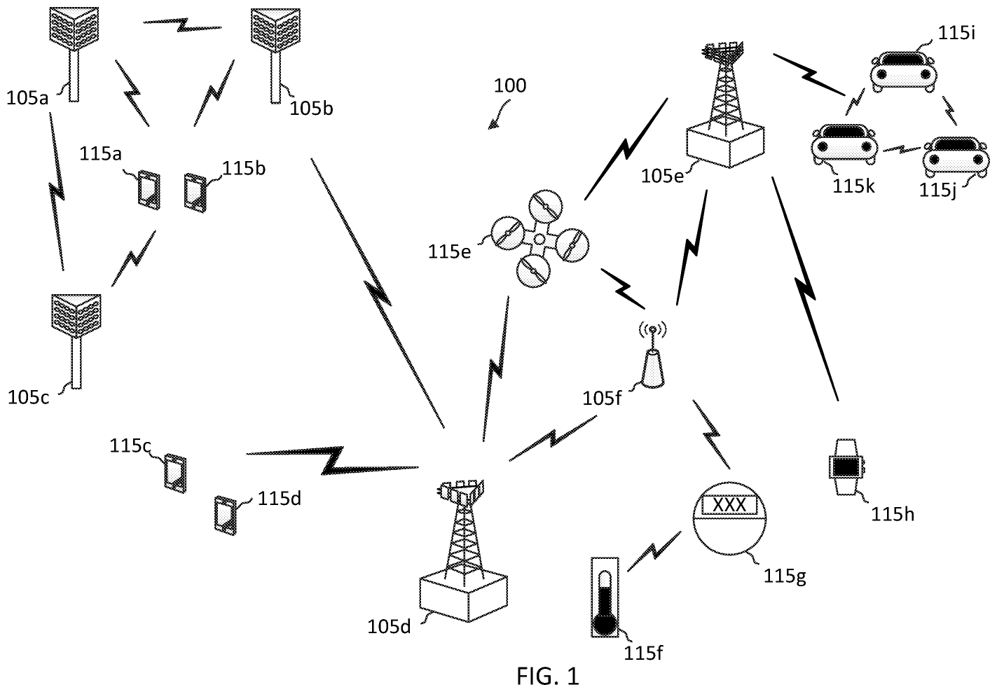

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

In some aspects, the UE 115g may receive a request from UE 115f to monitor for at least one of a paging signal associated with the UE 115f or a wakeup signal (WUS) associated with the UE 115f. The UE 115g may monitor for the paging signal or the wakeup signal based on the request. In some aspects, the UE 115g may receive the paging signal or the wakeup signal from the BS 105f. The UE 115g may transmit the paging signal or the wakeup signal to the UE 115f. Aspects of the present disclosure may enable power consumption reduction in the UE 115f by configuring the UE 115g to monitor for the paging signal and/or the WUS from the BS 105f while the UE 115f remains in a low power mode (e.g., a sleep mode).

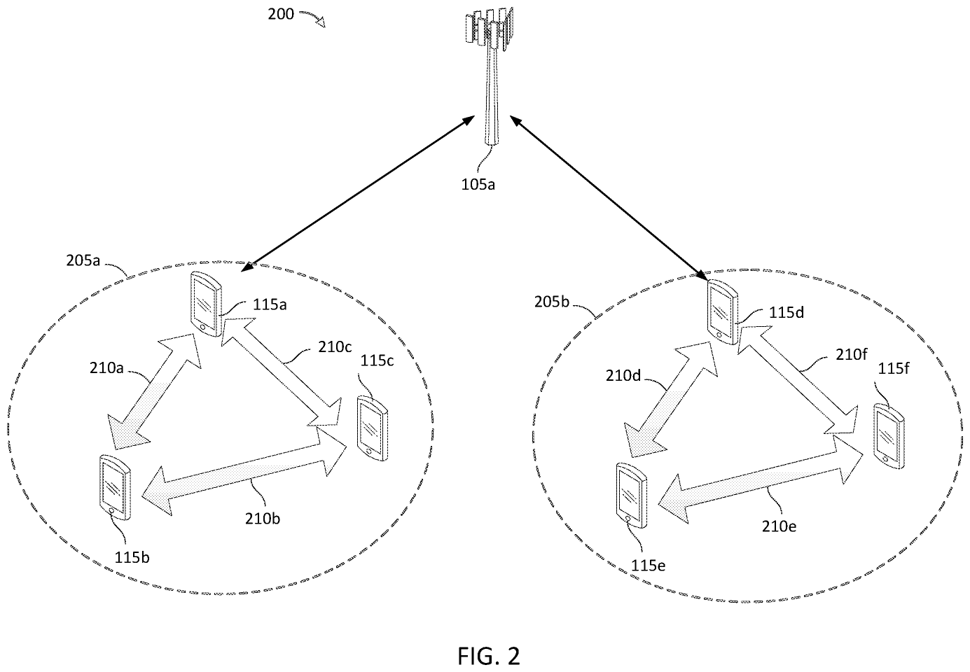

FIG. 2 illustrates a wireless communication network 200 according to some aspects of the present disclosure. The wireless communications network 200 may include a base station 105a and sidelink UEs 115a, 115b, 115c, 115d, 115e, and 115f which may be examples of a BS 105 and a UE 115 as described with reference to FIG. 1. Base station 105a and UEs 115a, 115b, and 115c may communicate within a geographic coverage area and via sidelink communication links 210a, 210b, and 210c. UE 115a may communicate with UEs 115b and 115c via sidelink communication links 210a and 210c, respectively. UE 115b may communicate with UEs 115a and 115c via sidelink communication links 210a and 210b, respectively. UE 115c may communicate with UEs 115a and 115b via sidelink communication links 210c and 210b, respectively. BS 105a and UEs 115d, 115e, and 115f may communicate within a geographic coverage area and via sidelink communication links 210d, 210e, and 210f. UE 115d may communicate with UEs 115e and 115f via sidelink communication links 210d and 210f, respectively. UE 115e may communicate with UEs 115d and 115f via sidelink communication links 210d and 210e, respectively. UE 115f may communicate with UEs 115d and 115e via sidelink communication links 210f and 210e, respectively.

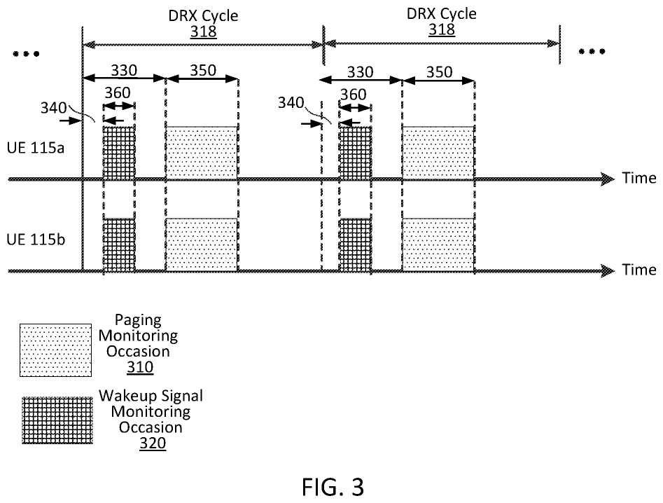

In some aspects, UEs 115a, 115b, and 115c may form a sidelink group 205a. UEs 115d, 115e, and 115f may form a different sidelink UE group 205b. Sidelink group 205a may include sidelink group leader 115a and sidelink group members UE 115b and UE 115c. Sidelink UE group 205b may include sidelink group leader UE 115d and sidelink group members UE 115e and UE 115f. The UEs 115 in groups 205a and 205b may move from one group to another group based on conditions described below with reference to FIGS. 3-7. In some aspects, the sidelink group leader UE 115a may receive a request from the UEs 115b and/or UE 115c to monitor for at least one of a paging signal associated with the UEs 115b and/or UE 115c and/or a wakeup signal (WUS) associated with the UEs 115b and/or UE 115c. The UE 115a may monitor for the paging signal or the WUS based on the request. The UE 115a may receive the paging signal or the WUS from the BS 105a. The UE 115a may transmit (e.g., forward) the paging signal or the WUS to the UEs 115b and/or UE 115c based on a UE ID associated with the paging signal or the WUS. Similarly, with respect to sidelink UE group 205b, the sidelink group leader UE 115d may receive a request from the UEs 115e and/or UE 115f to monitor for at least one of a paging signal associated with the UEs 115e and/or UE 115f or a WUS associated with the UEs 115e and/or UE 115f. The UE 115d may monitor for the paging signal or the WUS based on the request. The UE 115d may receive the paging signal or the WUS from the BS 105a. The UE 115d may transmit (e.g., forward) the paging signal or the WUS to the UEs 115e and/or UE 115f based on a UE ID associated with the paging signal or the WUS. Aspects of the present disclosure may enable power consumption reduction in the UE group members 115b, 115c, 115e, and 115f by configuring the UE group leaders 115a and 115d to monitor for the paging signal and/or the WUS from the BS 105a while the UE group members 115b, 115c, 115e, and 115f remains in a low power mode (e.g., a sleep mode).

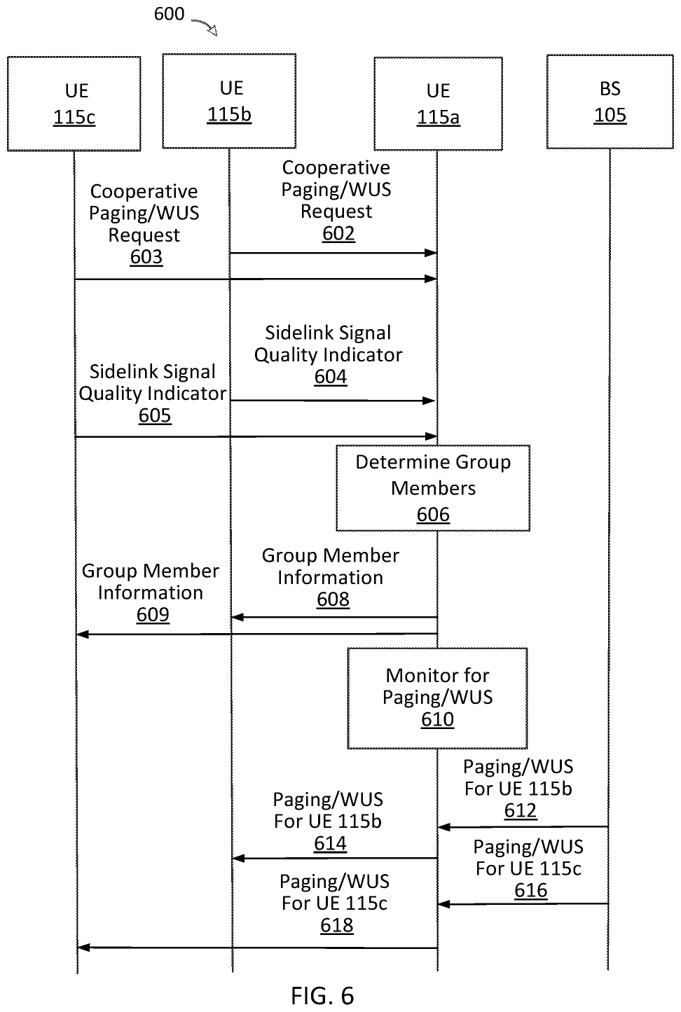

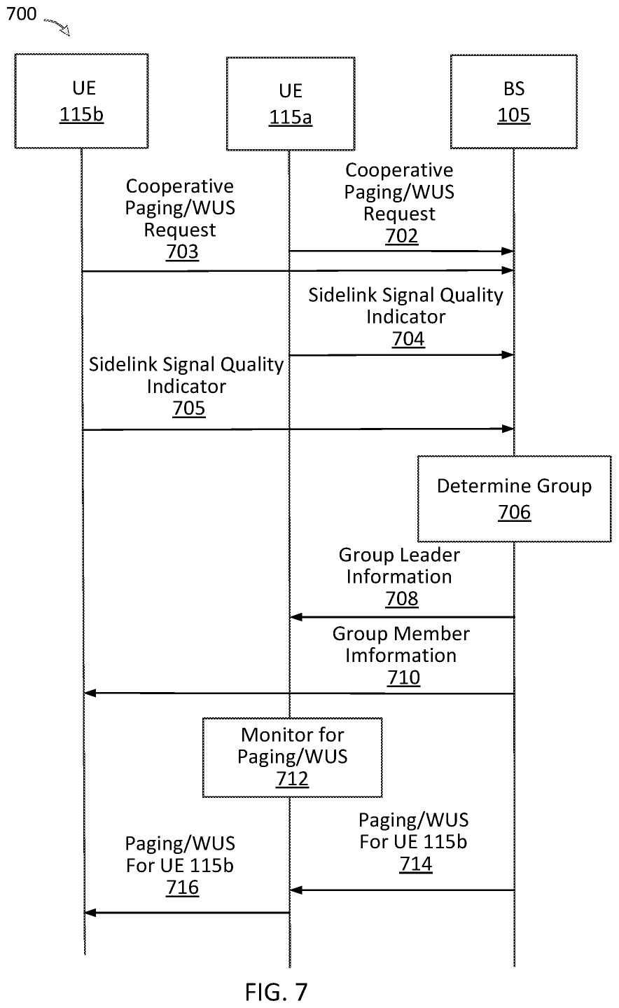

The UE group leaders UE 115a and/or 115d may form the sidelink group based on the UE group members 115a, 115b, 115c, 115d, 115e, and 115f having the same, overlapping, or consecutive WUS monitoring occasions and/or paging monitoring occasions as described below with reference to FIGS. 3-5. Additionally or alternatively, the UE group leaders UE 115a and/or 115d may form the sidelink group based on a sidelink signal quality and/or a Uu signal link quality as described below with reference to FIGS. 6 and 7.

FIG. 3 illustrates paging monitoring occasions 310 and WUS monitoring occasions 320 according to some aspects of the present disclosure. In FIG. 3, the x-axis represents time in some arbitrary units. FIG. 3 illustrates paging monitoring occasions 310 and WUS monitoring occasions 320 for sidelink UE 115a (e.g., the UE group leader) and sidelink UE 115b (e.g., the UE group member). The UE 115b may transmit a request to the UE 115a to monitor for a paging signal and/or a WUS associated with the UE 115b. The request may include information regarding the paging signal and/or WUS, such as an indicator indicating a paging monitoring occasion 310 associated with the UE 115b, an indicator indicating a WUS monitoring occasion 320 associated with the UE 115b, a threshold value associated with a sidelink signal quality, and/or an identifier associated with the UE 115b. The information included in the request from the UE 115b may be used by the UE 115a to determine a response to the request. For example, the UE 115a may determine whether to monitor for the paging signal and/or the WUS associated with the UE 115b based on whether the UE 115a and the UE 115b have the same paging monitoring occasion 310 and/or the same WUS monitoring occasion 320. The UE 115b may transmit the request to the UE 115a including information associated with the UE 115b's paging monitoring occasion 310 and/or WUS monitoring occasion 320. The information associated with the UE 115b's paging monitoring occasion 310 and/or WUS monitoring occasion 320 may include periodicity, for example DRX cycle 318, a WUS timing offset 340 (e.g., a timing offset from the beginning of a DRX cycle 318), a paging timing offset 330 (e.g., a timing offset from the beginning of a DRX cycle 318 and/or a time duration 350 of the UE 115b's paging monitoring occasion 310 (e.g., time during which the UE 115 monitors for paging) and/or a time duration 360 of WUS monitoring occasion 320 (e.g., time during which the UE 115 monitors for a WUS). When the UE 115a and the UE 115b have the same paging monitoring occasion 310 and/or WUS monitoring occasion 320, the UE 115a may transmit a response message to the UE 115b indicating that the UE 115a will monitor for at least one of a paging signal associated with the UE 115b or a WUS associated with the UE 115b. The UE 115a may respond to the request from the UE 115b indicating that the UE 115b is a UE group member and the UE 115a is a UE group leader. In some aspects, when the UE 115a and the UE 115b do not have the same paging monitoring occasion 310 and/or WUS monitoring occasion 320, the UE 115a may transmit a response message to the UE 115b indicating that the UE 115a will not monitor for a paging signal associated with the UE 115b or a WUS associated with the UE 115b. The UE 115a may receive requests for monitoring paging signals and/or WUSs from multiple UEs. The UE 115a may respond to the requests from multiple UEs indicating whether the requesting UEs will be UE group members. For example, if the requesting UE indicates a different paging monitoring occasion 310 and/or a different WUS monitoring occasion 320 than the paging monitoring occasion 310 and/or WUS monitoring occasion 320 of the UE 115a, the UE 115a may respond to the request indicating that the UE 115a will not monitor for the paging signal and/or the WUS associated with the requesting UE. In this case, the requesting UE 115b may transmit a request to a UE 115 different from the UE 115a to monitor for a paging signal and/or a WUS associated with the UE 115b.

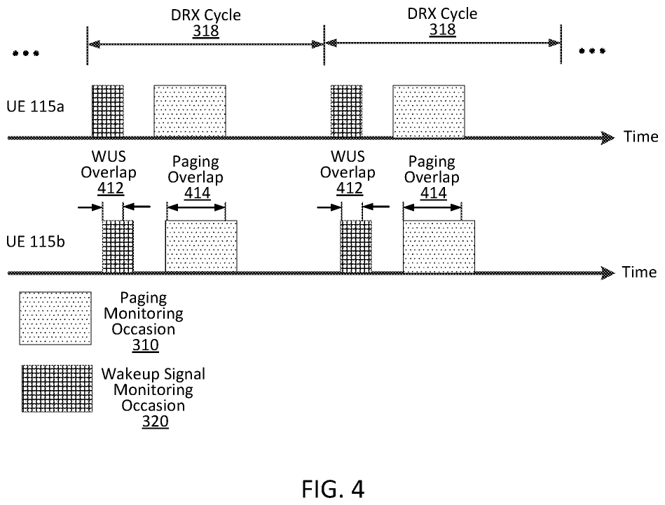

FIG. 4 illustrates paging monitoring occasions 310 and WUS monitoring occasions 320 according to some aspects of the present disclosure. In FIG. 4, the x-axis represents time in some arbitrary units. FIG. 4 illustrates paging monitoring occasions 310 and WUS monitoring occasions 320 for sidelink UE 115a (e.g., the UE group leader) and sidelink UE 115b (e.g., the UE group member). In some aspects, the UE 115a may determine whether to monitor for the paging signal and/or the WUS associated with the UE 115b based on whether the UE 115a and the UE 115b have overlapping paging monitoring occasions 310 and/or overlapping WUS monitoring occasions 320. The UE 115a and the UE 115b may have any amount of overlapping paging monitoring occasion 310 and/or overlapping WUS monitoring occasion 320. The UE 115b may transmit the request including information associated with the UE 115b's paging monitoring occasion 310 and/or WUS monitoring occasion 320. The information associated with the UE 115b's paging monitoring occasion 310 and/or WUS monitoring occasion 320 may include periodicity (e.g., DRX cycle 318), timing offset (e.g., timing offset from the beginning of a DRX cycle 318) and/or time duration of the UE 115b's paging monitoring occasion 310 and/or WUS monitoring occasion 320. When the UE 115a and the UE 115b have a paging overlap 414 in the paging monitoring occasions 310 and/or a WUS overlap 412 in the WUS monitoring occasions 320, the UE 115a may transmit a response message to the UE 115b indicating that the UE 115a will monitor for at least one of a paging signal associated with the UE 115b or a WUS associated with the UE 115b. For example, the paging monitoring occasion 310 of the UE 115a and the paging monitoring occasion 310 of the UE 115b may have an overlapping time period WUS overlap 414 when the paging monitoring occasions 310 partially occur simultaneously. The WUS monitoring occasion 320 of the UE 115a and the WUS monitoring occasion 320 of the UE 115b may have an overlapping time period paging overlap 412 when the WUS monitoring occasions 320 partially occur simultaneously. The UE 115a may respond to the UE 115b's request indicating that the UE 115b is a UE group member and the UE 115a is a UE group leader. In some aspects, when the UE 115a and the UE 115b do not have an overlap in the paging monitoring occasion 310 and/or the WUS monitoring occasion 320, the UE 115a may transmit a response message to the UE 115b indicating that the UE 115a will not monitor for a paging signal associated with the UE 115b or a WUS associated with the UE 115b.

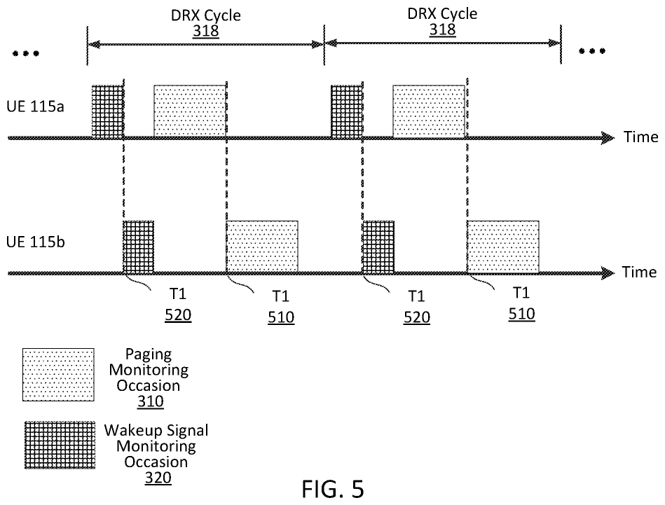

FIG. 5 illustrates paging monitoring occasions 310 and WUS monitoring occasions 320 according to some aspects of the present disclosure. In FIG. 5, the x-axis represents time in some arbitrary units. FIG. 5 illustrates paging monitoring occasions 310 and WUS monitoring occasions 320 for sidelink UE 115a (e.g., the UE group leader) and sidelink UE 115b (e.g., the UE group member). In some aspects, the UE 115a may determine whether to monitor for the paging signal and/or the WUS associated with the UE 115b based on whether the UE 115a and the UE 115b have different paging monitoring occasions 310 (e.g., the paging monitoring occasion(s) 310 for the UE 115a are not aligned (simultaneous) and do not overlap with the paging monitoring occasion(s) 310 for the UE 115b) and/or the WUS monitoring occasions 320 (e.g., the WUS monitoring occasion(s) 320 for the UE 115a are not aligned and do not overlap with the WUS monitoring occasion(s) 320 for the UE 115b). The UE 115b may transmit the request to the UE 115a including information associated with the UE 115b's paging monitoring occasion 310 and/or WUS monitoring occasion 320. The information associated with the UE 115b's paging monitoring occasion 310 and/or WUS monitoring occasion 320 may include periodicity (e.g., DRX cycle 318, timing offset (e.g., timing offset from the beginning of a DRX cycle 318) and/or time duration of the UE 115b's paging monitoring occasion 310 and/or WUS monitoring occasion 320. When the UE 115a and the UE 115b have different paging monitoring occasions 310 and/or WUS monitoring occasions 320, the UE 115a may transmit a response message to the UE 115b indicating that the UE 115a will monitor for at least one of a paging signal associated with the UE 115b or a WUS associated with the UE 115b.

In some instances, the paging monitoring occasion 310 of the UE 115a and the paging monitoring occasion 310 of the UE 115b may occur during different time periods. For example, a paging monitoring occasion 310 of the UE 115b may occur immediately before and/or immediately after a paging monitoring occasion 310 of the UE 115a. The paging monitoring occasions 310 of the UE 115a and the UE 115b may be contiguous (e.g., adjacent) in time. For example, the paging monitoring occasion 310 of the UE 115b may occur immediately after a paging monitoring occasion 310 of the UE 115a at time T1 510. In some aspects, the paging monitoring occasions 310 of the UE 115a and the UE 115b may be non-contiguous (e.g., spaced apart) in time.

The WUS monitoring occasion 320 of the UE 115a and the WUS monitoring occasion 320 of the UE 115b may occur during different time periods. The WUS monitoring occasion 320 of the UE 115b may occur immediately before and/or immediately after the WUS monitoring occasion 320 of the UE 115a. The WUS monitoring occasions 320 of the UE 115a and the UE 115b may be contiguous (e.g., adjacent) in time. For example, the WUS monitoring occasion 320 of the UE 115b may occur immediately after the WUS monitoring occasion 320 of the UE 115a at time T2 520. In some aspects, the WUS monitoring occasions 320 of the UE 115a and the UE 115b may be non-contiguous (e.g., spaced apart) in time.

In some instances, the UE 115a may respond to the request from the UE 115b indicating that the UE 115b is a UE group member and the UE 115a is a UE group leader. In some aspects, when the UE 115a and the UE 115b do not have aligned, overlapping, and/or contiguous (e.g., adjacent) paging monitoring occasions 310 and/or WUS monitoring occasions 320 (e.g., the paging monitoring occasions 310 and/or the WUS monitoring occasions 320 are non-contiguous), the UE 115a may transmit a response message to the UE 115b indicating that the UE 115a will not monitor for a paging signal associated with the UE 115b or a WUS associated with the UE 115b.

When the paging monitoring occasion 310 and/or WUS monitoring occasion 320 of the UE 115a is the same as the UE 115b, overlaps with the UE 115b, and/or is contiguous to the UE 115b, the UE 115a may monitor for the paging signal and/or WUS intended for the UE 115a as well as the paging signal and/or WUS intended for the UE 115b. The UE 115a may monitor for the paging signal and/or WUS intended for the UE 115a as well as the paging signal and/or WUS intended for the UE 115b without entering a sleep mode. Although the example discussed above describes a single UE group leader monitoring for the paging signal and/or WUS intended for a single UE group member (e.g., the UE 115b), the UE group leader (e.g., the UE 115a) may monitor for the paging signal and/or WUS intended for the UE group leader and the paging signals and/or WUSs intended for multiple UE group members. In some instances, after monitoring for the paging signal and/or WUS intended for the UE group leader and multiple UE group members, the UE group leader may enter a sleep mode. The UE group leader may wakeup from the sleep mode based on a DRX cycle 318 period of the UE group leader.

FIG. 6 is a signaling diagram of a communication method 600 according to some aspects of the present disclosure. Actions of the signaling diagram 600 can be executed by a computing device (e.g., a processor, processing circuit, and/or other suitable component) of a communication device or other suitable means for performing the actions. For example, a wireless communication device, such as the UE 115 or UE 800, may utilize one or more components, such as the processor 802, the memory 804, the cooperative paging and WUS module 808, the transceiver 810, the modem 812, and the one or more antennas 816, to execute the aspects of signaling diagram 600. For example, a wireless communication device, such as the BS 105 or BS 900, may utilize one or more components, such as the processor 902, the memory 904, the cooperative paging and WUS module 908, the transceiver 910, the modem 912, and the one or more antennas 916, to execute the aspects of signaling diagram 600.

At action 602, the UE 115b may transmit a cooperative paging/WUS request to the UE 115a. The UE 115b may transmit the request to the UE 115a to monitor for at least one of a paging signal associated with the UE 115b or a WUS associated with the UE 115b. In this regard, the UE 115a may receive the request from the UE 115b via a physical sidelink control channel (PSCCH), a physical sidelink shared channel (PSSCH), sidelink control information (SCI), or other suitable communication. In some aspects, the UE 115a, the UE 115b, and the UE 115c may be sidelink UEs in communication with each other. The UE 115a, the UE 115b, and the UE 115c may be included in a sidelink group. The sidelink group may include any number of UEs (e.g., two UEs, three UEs, four UEs, etc.). The sidelink group may include UE group members UE 115b and UE 115c and UE group leader UE 115a. The UE group leader UE 115a may monitor for a paging signal and/or a WUS transmitted by BS 105 that is intended for the UE group member 115b and forward the paging signal and/or the WUS to the UE 115b. Aspects of the present disclosure may enable power consumption reduction in the UE 115b by allowing the UE 115a to monitor for the paging signal and/or the WUS while the UE 115b remains in a low power mode (e.g., a sleep mode).

At action 603, the UE 115c may transmit a cooperative paging/WUS request to the UE 115a. The UE 115c may transmit the request to the UE 115a to monitor for at least one of a paging signal associated with the UE 115c or a WUS associated with the UE 115c. In this regard, the UE 115a may receive the request from the UE 115c via a PSCCH, a PSSCH, SCI, or other suitable communication. The UE group leader UE 115a may monitor for a paging signal and/or a WUS transmitted by BS 105 that is intended for the UE group member 115c and forward the paging signal and/or the WUS to the UE 115c. Aspects of the present disclosure may enable power consumption reduction in the UE 115c by allowing the UE 115a to monitor for the paging signal and/or the WUS while the UE 115c remains in a low power mode (e.g., a sleep mode).

At action 604, the UE 115b may transmit a sidelink signal quality indicator to the UE 115a. At action 605, the UE 115c may transmit a sidelink signal quality indicator to the UE 115a. In this regard, the UE 115a may receive the sidelink signal quality indicators via a sidelink radio resource control (SL-RRC) message, a PSCCH, a PSSCH, SCI, or other suitable communication. In some aspects, the UE 115a (e.g., the UE group leader) may monitor for the paging signal and/or the WUS signal of the UE 115b and UE 115c (e.g., the UE group members) based on a sidelink signal quality associated with the UE 115b and UE 115c satisfying a threshold value. In some aspects, the UE 115b and UE 115c may transmit an indicator indicating a sidelink signal quality threshold value to the UE 115a. In some aspects, the UE 115a may receive the threshold value from the UE 115b and UE 115c via the request to monitor for the paging signal and/or the WUS at actions 602 and 603 respectively. In some aspects, the threshold value may be stored (e.g., hard coded) in the UE 115a. The UE 115a may store a table of threshold values from which the UE 115a may choose from. In some aspects, the threshold value may be stored (e.g., hard coded) in the UE 115b and/or UE 115c and transmitted to the UE 115a.

When the sidelink signal quality associated with the UE 115b satisfies the threshold value, the signal quality between the UE 115a and the UE 115b may be suitable for the UE 115a to monitor for the paging signal and/or the WUS and transmit the paging signal and/or the WUS to the UE 115b. When the sidelink signal quality associated with the UE 115c satisfies the threshold value, the signal quality between the UE 115a and the UE 115c may be suitable for the UE 115a to monitor for the paging signal and/or the WUS and transmit the paging signal and/or the WUS to the UE 115c. The sidelink signal quality associated with the UE 115b and UE 115c may be determined using any suitable method. For example, the UE 115a may measure the sidelink signal quality based on communications from the UE 115b and/or the UE 115c.

For example, the UE 115b and/or the UE 115c may transmit a reference signal (e.g., a demodulation reference signal (DMRS), a sidelink channel state information reference signal (SL CSI-RS), synchronization signal block (SSB), the request message, or any suitable communication to the UE 115a. The UE 115a may measure a signal-to-interference-plus-noise ratio (SINR), a reference signal received power (RSRP), and/or a received signal strength indicator (RSSI) associated with the sidelink communication from the UE 115b and UE 115c to the UE 115a. The UE 115a may compare the measured sidelink signal quality to the sidelink signal quality threshold value.

Additionally or alternatively, the UE 115a (e.g., the UE group leader) may monitor for the paging signal and/or the WUS signal associated with the UE 115b and/or the UE 115c (e.g., the UE group members) based on a sidelink signal quality associated with the UE 115a satisfying a threshold value. In some aspects, the UE 115a may transmit an indicator indicating a sidelink signal quality threshold value to the UE 115b and/or UE 115c. In this regard, the UE 115a may transmit the threshold value to the UE 115b and/or UE 115c via a SL-RRC message, a PSCCH, a PSSCH, SCI, or other suitable communication. In some aspects, the threshold value may be stored (e.g., hard coded) in the UE 115b and UE 115c. In some aspects, the threshold value may be stored (e.g., hard coded) in the UE 115a and transmitted to the UE 115b and UE 115c.

When the sidelink signal quality associated with the UE 115a satisfies the threshold value, the signal quality between the UE 115a and the UE 115b and UE 115c may be suitable for the UE 115a to monitor for the paging signal and/or the WUS and transmit the paging signal and/or the WUS to the UE 115b and/or UE 115c. The sidelink signal quality associated with the UE 115a may be determined using any suitable method. For example, the UE 115b and UE 115c may measure the quality of the sidelink signal based on communications from the UE 115a. For example, the UE 115a may transmit a reference signal (e.g., a DMRS, a SL CSI-RS, a SSB), or any suitable communication to the UE 115b and/or UE 115c. The UE 115b and/or UE 115c may measure a SINR, a RSRP, and/or a RSSI associated with the sidelink communication from the UE 115a to the UE 115b and/or UE 115c. The UE 115b and/or the UE 115c may transmit an indicator to the UE 115a indicating whether the sidelink signal quality associated with the UE 115a satisfies the threshold value (e.g., the measured signal quality is greater than the threshold value). Additionally or alternatively, the UE 115b and UE 115c may transmit a report (e.g., a CSI-RS report) to the UE 115a indicating the sidelink signal quality associated with the communication from the UE 115a. The UE 115a may determine whether the sidelink signal quality associated with the UE 115a satisfies the threshold value based on the report.

In some aspects, the UE 115a (e.g., the UE group leader) may monitor for the paging signal and/or the WUS signal of the UE 115b and UE 115c (e.g., a UE group member) based on a signal quality between the UE 115a and the BS 105 (e.g., a Uu link quality) satisfying a threshold value. In some aspects, the Uu link may be a directional beam between the UE 115a and the BS 105. In some aspects, the BS 105 may be unaware of the UE 115a monitoring for the paging signal and/or the WUS signal of the UE 115b and UE 115c. In this case, the threshold value may be stored (e.g., hard coded) in the UE 115a. In some aspects, the threshold value may be stored (e.g., hard coded) in the UE 115b and UE 115c and transmitted to the UE 115a. In this regard, the UE 115b and/or the UE 115c may transmit the Uu threshold value to the UE 115a via a SL-RRC message, a PSCCH, a PSSCH, SCI, or other suitable communication. In some aspects, the UE 115a may receive the Uu signal quality threshold value from the UE 115b and/or the UE 115c via the request to monitor for the paging signal and/or the WUS at action 602/603.

When the Uu signal quality associated with communications between the UE 115a and the BS 105 satisfies the threshold value, the signal quality between the BS 105 and the UE 115a may be suitable for the UE 115a to monitor for the paging signal and/or the WUS from the BS 105 and transmit the paging signal and/or the WUS to the UE 115b and/or the UE 115c. The Uu signal quality associated with the communications between the BS 105 and the UE 115a may be determined using any suitable method. For example, the UE 115a may measure the quality of the Uu signal based on downlink communications from the BS 105. For example, the UE 115a may receive a reference signal (e.g., a DMRS, a CSI-RS, a sounding reference signal (SRS)), or any suitable communication from the BS 105. The UE 115a may measure a SINR, a RSRP, and/or a RSSI associated with the communication from the BS 105 to the UE 115a. The UE 115a may determine whether to monitor for a paging signal and/or a WUS associated with the UE 115b and/or the UE 115c based on whether the Uu signal quality associated with communications between the UE 115a and the BS 105 satisfies the threshold value (e.g., the measured signal quality is greater than the threshold value). The UE 115a may not monitor for a paging signal and/or a WUS associated with the UE 115b and/or the UE 115c when the Uu signal quality associated with communications between the UE 115a and the BS 105 does not satisfy the threshold value (e.g., the measured signal quality is less than the threshold value).

In some aspects, the UE 115a may periodically determine the Uu signal quality. The Uu signal quality may change over time based on channel conditions, UE 115a movement, and/or distance between the BS 105 and the UE 115a. The UE 115a may periodically determine the Uu signal quality to determine whether the UE 115a should monitor (continue to monitor) for a paging signal and/or a WUS associated with the UE 115b and/or the UE 115c. For example, the UE 115a may discontinue monitoring for a paging signal and/or a WUS associated with the UE 115b and UE 115c when the signal quality between the UE 115a and the BS 105 drops below the threshold level. In this case, the UE 115a may transmit an indicator to the UE 115b and/or the UE 115c indicating that the UE 115a will discontinue monitoring for a paging signal and/or a WUS associated with the UE 115b and/or the UE 115c. The UE 115b and/or the UE 115c may then monitor for a paging signal and/or a WUS directly from the BS 105 and/or send a request to another UE 115 to monitor the paging signal and/or the WUS for the UE 115b and/or the UE 115c.

At action 606, the UE 115a may determine the sidelink UE group members. The UE 115a may determine the UE group members based at least on the paging/WUS monitoring occasions described above at actions 602/603 and/or on the sidelink/Uu signal quality described above at actions 604/605.

At action 608, the UE 115a may transmit an indication to the UE 115b indicating whether the UE 115b satisfies the criteria for being a group member based on the determination at action 606.

At action 609, the UE 115a may transmit an indication to the UE 115c indicating whether the UE 115b satisfies the criteria for being a group member based on the determination at action 606.

At action 610, the UE 115a may monitor for the paging signal and/or the WUS associated with the UE 115b and/or the UE 115c based on the determination at action 606.

At action 612, the UE 115a may receive a paging signal and/or a WUS from the BS 105. The paging signal and/or WUS may be intended for the UE 115b. In this regard, the UE 115a may receive the paging signal and/or the WUS intended for the UE 115b via a physical downlink shared channel (PDSCH), a paging transport channel (PCH), and/or a paging control channel (PCCH). In some aspects, the BS 105 may be unaware that the UE 115a is monitoring for and receiving the paging signal and/or the WUS intended for the UE 115b. The UE 115a may monitor and receive (e.g., decode) the paging signal and/or the WUS intended for the UE 115b based on information received from the UE 115b at action 602. For example, the UE 115a may receive the paging signal associated with the UE 115b based on the UE identifier and the paging monitoring occasion associated with the UE 115b. The UE 115a may decode the paging signal intended for the UE 115b using the UE 115b's ID during the paging monitoring occasion associated with the UE 115b.

The UE 115a may receive the WUS associated with the UE 115b based on the UE identifier and the WUS monitoring occasion associated with the UE 115b. For example, the UE 115a may decode the WUS intended for the UE 115b using the UE 115b's ID during the WUS monitoring occasion associated with the UE 115b.

At action 614, the UE 115a may transmit, to the UE 115b, the paging signal and/or the WUS intended for the UE 115b. In this regard, when the UE 115a decodes the paging signal and/or the WUS intended for the UE 115b, the UE 115a may transmit an indicator to the UE 115b indicating whether the UE 115b should wake up. Additionally or alternatively, the UE 115a may transmit an indicator to the UE 115b indicating whether the UE 115b should enter or remain in a sleep mode. For example, the UE 115a may transmit a codepoint indicator to the UE 115b. The codepoint indicator may be a single bit indicating whether the UE 115b should wake up (e.g., a codepoint value of 1) or enter/remain in sleep mode (e.g., a codepoint value of 0).

Additionally or alternatively, the UE 115a may receive the paging signal and/or the WUS intended for the UE 115b from the BS 105 and transmit (e.g., forward) the paging signal and/or the WUS to the UE 115b without decoding the paging signal and/or the WUS. For example, the UE 115a may not receive or be aware of the ID associated with the UE 115b. In this case, the UE 115a may function as a repeater node receiving the paging signal and/or the WUS from the BS 105 and transmitting (e.g., repeating) the paging signal and/or the WUS over a sidelink communication (e.g., a PSCCH, a PSSCH, SCI, etc.) without decoding the paging signal and/or the WUS intended for the UE 115b. The UE 115b may monitor for sidelink communications forwarded by the UE 115a from the BS 105 and decode the paging signal and/or the WUS intended for the UE 115b. The UE 115b may monitor for sidelink communications forwarded by the UE 115a from the BS 105 based on resources indicated in downlink control information (e.g., DCI format 1_0) transmitted by the BS 105 to the UE 115b.

At action 616, the UE 115a may receive a paging signal and/or a WUS from the BS 105. The paging signal and/or WUS may be intended for the UE 115c. The UE 115a may receive the paging signal and/or WUS intended for the UE 115c similar to the actions described above at action 612.

At action 618, the UE 115a may transmit, to the UE 115c, the paging signal and/or the WUS intended for the UE 115c. The UE 115a may transmit, to the UE 115c, the paging signal and/or the WUS intended for the UE 115c similar to the actions described above at action 614.

FIG. 7 is a signaling diagram of a communication method 700 according to some aspects of the present disclosure. Actions of the signaling diagram 700 can be executed by a computing device (e.g., a processor, processing circuit, and/or other suitable component) of a communication device or other suitable means for performing the actions. For example, a wireless communication device, such as the UE 115 or UE 800, may utilize one or more components, such as the processor 802, the memory 804, the cooperative paging and WUS module 808, the transceiver 810, the modem 812, and the one or more antennas 816, to execute the aspects of signaling diagram 700. For example, a wireless communication device, such as the BS 105 or BS 900, may utilize one or more components, such as the processor 902, the memory 904, the cooperative paging and WUS module 908, the transceiver 910, the modem 912, and the one or more antennas 916, to execute the aspects of signaling diagram 700.

At action 702, the BS 105 may receive a request from the UE 115a to receive a paging signal associated with the UE 115b or a WUS associated with the UE 115b. In this regard, the BS 105 may receive the request from the UE 115a via a PUCCH, a PUSCH, UCI, or other suitable communication.

At action 703, the BS 105 may receive a request from the UE 115b to receive a paging signal associated with the UE 115b or a wakeup signal associated with the UE 115b from the UE 115a. In this regard, the BS 105 may receive the request from the UE 115b via a PUCCH, a PUSCH, UCI, or other suitable communication.

At action 704, the UE 115a may transmit a sidelink signal quality indicator to the BS 105. At action 705, the UE 115b may transmit a sidelink signal quality indicator to the BS 105. In this regard, the BS 105 may receive the sidelink signal quality indicators via a PUCCH, a PUSCH, UCI, or other suitable communication.

At action 706, the BS 105 may determine the sidelink group. In some aspects, the sidelink group may be formed based on the UE 115a and UE 115b determining the sidelink group leader and the sidelink group members as described above with reference to method 600. In this case, the sidelink group leader may indicate the sidelink group leader and the sidelink group members to the BS 105. In some aspects, the BS 105 may assist in forming the sidelink group. In this regard, the BS 105 may receive from the UE 115a an indicator indicating which sidelink UEs among sidelink UEs in proximity to the UE 115a has the highest sidelink signal quality. For example, the UE 115a may determine that the UE 115b has the highest sidelink signal quality among sidelink UEs in proximity to the UE 115a. The BS 105 may receive an indicator (e.g., a report) indicating an identifier of the UE 115b that has the highest sidelink signal quality among sidelink UEs in proximity to the UE 115a. The UE 115b may be considered a group member based on having the highest sidelink signal quality.

In some aspects, the BS 105 may determine the number (e.g. a positive integer) of sidelink UEs that form the sidelink group. The BS 105 may transmit the number of sidelink UEs that form the sidelink group to the UE 115a via a PDCCH communication, a PDSCH communication, an RRC message, or downlink control information (DCI). The UE 115a may determine the sidelink signal quality among sidelink UEs in proximity to the UE 115a. The UE may select the number of sidelink UEs indicated by the BS 105 that have the highest sidelink signal quality. The BS 105 may receive an indicator (e.g., a report) indicating the identifiers of the sidelink UEs that have the highest sidelink signal quality. The identifiers of the sidelink UEs that have the highest sidelink signal quality may include the UE 115b. The number of sidelink UEs indicated by the BS 105 may be considered group members based on having the highest sidelink signal quality.

Additionally or alternatively, the BS 105 may transmit a sidelink signal quality threshold value to the UE 115a. In this regard, the BS 105 may transmit the sidelink signal quality threshold value to the UE 115a via a PDCCH communication, a PDSCH communication, an RRC message, or DCI. The UE 115a may determine the sidelink signal quality among sidelink UEs in proximity to the UE 115a. The UE 115a may select all or a subset of sidelink UEs having a sidelink signal quality that satisfies the sidelink signal quality threshold value indicated by the BS 105. The BS 105 may receive an indicator (e.g., a report) indicating the identifiers of the sidelink UEs that have a sidelink signal quality that satisfies the sidelink signal quality threshold value. The identifiers of the sidelink UEs that have a sidelink signal quality that satisfies the sidelink signal quality threshold value may include the UE 115b. The sidelink UEs that have a sidelink signal quality that satisfies the sidelink signal quality threshold value may be considered group members.

At action 708, the BS 105 may transmit an indicator to the UE 115a indicating that the UE 115a has been designated as the sidelink group leader based on the sidelink group determination at action 706. In this regard, the BS 105 may transmit the indicator to the UE 115a via a PDCCH communication, a PDSCH communication, an RRC message, or DCI.

At action 710, the BS 105 may transmit an indicator to the UE 115b indicating that the UE 115b has been designated as the sidelink group member based on the sidelink group determination at action 706. In this regard, the BS 105 may transmit the indicator to the UE 115b via a PDCCH communication, a PDSCH communication, an RRC message, or DCI.

At action 712, the UE 115a may monitor for the paging signal and/or the wakeup signal intended for the UE 115b based on resources indicated in downlink control information (e.g., DCI format 1_0) transmitted by the BS 105 to the UE 115a and/or transmitted by the BS 105 to the UE 115b and forwarded to the UE 115a. The UE 115a may monitor for the paging signal and/or the WUS associated intended for the UE 115b during the UE 115b's paging occasion and/or WUS occasion.

At action 714, the BS 105 may transmit the paging signal and/or the WUS intended for the UE 115b and other sidelinks UEs in the group to the UE 115a. The UE 115a may monitor and receive (e.g., decode) the paging signal and/or the WUS associated with the UE 115b based on information received from the UE 115b. For example, the UE 115a may receive the paging signal associated with the UE 115b based on the UE identifier and the paging monitoring occasion associated with the UE 115b. The UE 115a may decode the paging signal intended for the UE 115b using the UE 115b's ID during the paging monitoring occasion associated with the UE 115b.

The UE 115a may receive the WUS associated with the UE 115b based on the UE identifier and the WUS monitoring occasion associated with the UE 115b. For example, the UE 115a may decode the WUS intended for the UE 115b using the UE 115b's ID during the WUS monitoring occasion associated with the UE 115b.

Additionally or alternatively, the BS 105 may combine the paging signal and/or the WUS intended for the UE 115b with the paging signal and/or the WUS intended for the UE 115a (e.g., the UE group leader). In some aspects, the BS 105 may combine the paging signals and/or the WUSs intended for each sidelink UE group member, including the UE 115b, with the paging signal and/or the WUS intended for the UE 115a (e.g., the UE group leader). In this case, the paging signal and/or the WUS transmitted to the UE 115a may include the identifier associated with the UE 115a, the UE 115b and/or identifiers associated with other sidelink UEs in the sidelink group (e.g., other sidelink UE group members). In some aspects, the BS 105 may transmit a bitmap to the UE 115a indicating which sidelink UEs in the group should receive a paging signal and/or a WUS. The bitmap may include one or more bits corresponding to each of the sidelink UEs in the group. The state of the bit (e.g., 0 or 1) may indicate whether the corresponding UE should receive the paging signal and/or the WUS.

At action 716, the UE 115a may transmit, to the UE 115b, the paging signal and/or the WUS intended for the UE 115b. In this regard, the UE 115a may transmit the paging signal and/or the wakeup signal to the UE 115b via PSSCH, a PSCCH or SCI. After receiving the paging signal and/or the WUS indicating sidelink group members (e.g., the bitmap), the UE 115a may transmit the paging signal and/or the WUS via a unicast message to the UE 115b and each of the sidelink group members indicated by the bitmap and/or the identifiers associated with the sidelink UEs in the sidelink group. Additionally or alternatively, the UE 115a may groupcast and/or broadcast the paging signal and/or the WUS to the UE 115b and sidelink group members indicated by the combined paging signal and/or WUS received from the BS 105.

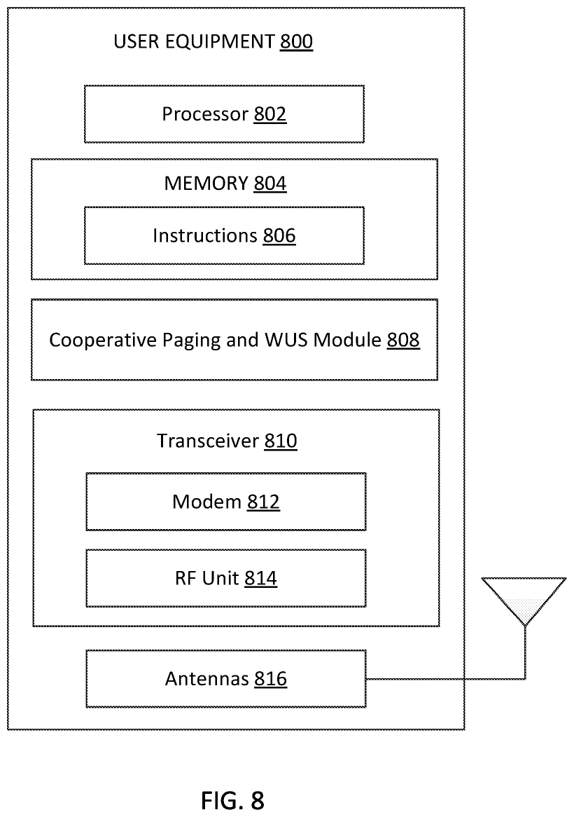

FIG. 8 is a block diagram of an exemplary UE 800 according to some aspects of the present disclosure. The UE 800 may be the UE 115 in the network 100 or 200 as discussed above. As shown, the UE 800 may include a processor 802, a memory 804, a cooperative paging and WUS module 808, a transceiver 810 including a modem subsystem 812 and a radio frequency (RF) unit 814, and one or more antennas 816. These elements may be coupled with each other and in direct or indirect communication with each other, for example via one or more buses.

The processor 802 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 804 includes a non-transitory computer-readable medium. The memory 804 may store instructions 806. The instructions 806 may include instructions that, when executed by the processor 802, cause the processor 802 to perform the operations described herein with reference to the UEs 115 in connection with aspects of the present disclosure, for example, aspects of FIGS. 2-7 and 10-11. Instructions 806 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The cooperative paging and WUS module 808 may be implemented via hardware, software, or combinations thereof. For example, the cooperative paging and WUS module 808 may be implemented as a processor, circuit, and/or instructions 806 stored in the memory 804 and executed by the processor 802.

In some aspects, the cooperative paging and WUS module 808 may be configured to receive a request from a second sidelink UE to monitor for at least one of a paging signal associated with the second sidelink UE or a wakeup signal (WUS) associated with the second sidelink UE. The cooperative paging and WUS module 808 may be configured to monitor for the paging signal or the wakeup signal based on the request. In some aspects, the cooperative paging and WUS module 808 may be configured to receive the paging signal or the wakeup signal from the BS. The cooperative paging and WUS module 808 may be configured to transmit the paging signal or the wakeup signal to the second sidelink UE. Aspects of the present disclosure may enable power consumption reduction in the second sidelink UE by configuring the first sidelink UE to monitor for the paging signal and/or the WUS from the BS while the second sidelink UE remains in a low power mode (e.g., a sleep mode).

As shown, the transceiver 810 may include the modem subsystem 812 and the RF unit 814. The transceiver 810 can be configured to communicate bi-directionally with other devices, such as the BSs 105 and/or the UEs 115. The modem subsystem 812 may be configured to modulate and/or encode the data from the memory 804 and the cooperative paging and WUS module 808 according to a modulation and coding scheme (MCS), e.g., a low-density parity check (LDPC) coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or a BS 105. The RF unit 814 may be further configured to perform analog beamforming in conjunction with the digital beamforming. Although shown as integrated together in transceiver 810, the modem subsystem 812 and the RF unit 814 may be separate devices that are coupled together to enable the UE 800 to communicate with other devices.

The RF unit 814 may provide the modulated and/or processed data, e.g. data packets (or, more generally, data messages that may contain one or more data packets and other information), to the antennas 816 for transmission to one or more other devices. The antennas 816 may further receive data messages transmitted from other devices. The antennas 816 may provide the received data messages for processing and/or demodulation at the transceiver 810. The antennas 816 may include multiple antennas of similar or different designs in order to sustain multiple transmission links. The RF unit 814 may configure the antennas 816.

In some instances, the UE 800 can include multiple transceivers 810 implementing different RATs (e.g., NR and LTE). In some instances, the UE 800 can include a single transceiver 810 implementing multiple RATs (e.g., NR and LTE). In some instances, the transceiver 810 can include various components, where different combinations of components can implement RATs.

In some aspects, the processor 802 may be coupled to the memory 804, the cooperative paging and WUS module 808, and/or the transceiver 810. The processor 802 and may execute operating system (OS) code stored in the memory 804 in order to control and/or coordinate operations of the cooperative paging and WUS module 808 and/or the transceiver 810. In some aspects, the processor 802 may be implemented as part of the cooperative paging and WUS module 808.

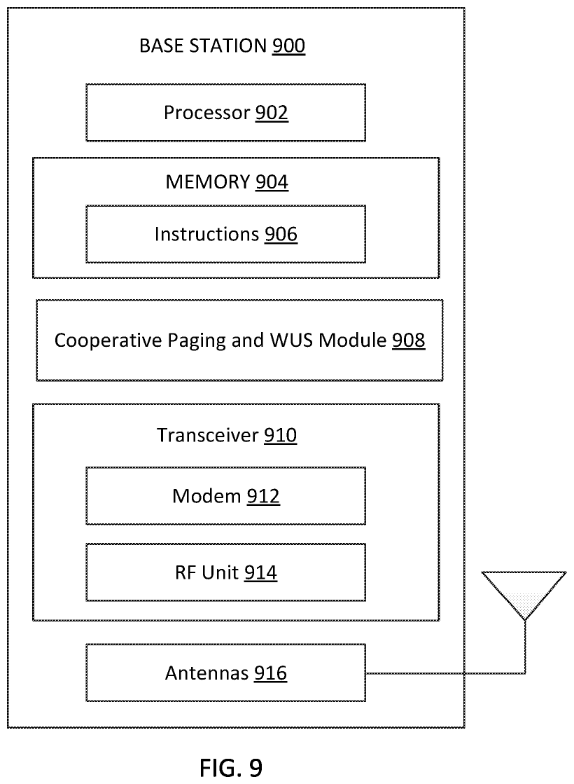

FIG. 9 is a block diagram of an exemplary BS 900 according to some aspects of the present disclosure. The BS 900 may be a BS 105 as discussed above. As shown, the BS 900 may include a processor 902, a memory 904, an cooperative paging and WUS module 908, a transceiver 910 including a modem subsystem 912 and a RF unit 914, and one or more antennas 916. These elements may be coupled with each other and in direct or indirect communication with each other, for example via one or more buses.

The processor 902 may have various features as a specific-type processor. For example, these may include a CPU, a DSP, an ASIC, a controller, a FPGA device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 904 may include a non-transitory computer-readable medium. The memory 904 may store instructions 906. The instructions 906 may include instructions that, when executed by the processor 902, cause the processor 902 to perform operations described herein, for example, aspects of FIGS. 2-7 and 10-11. Instructions 906 may also be referred to as code, which may be interpreted broadly to include any type of computer-readable statement(s).

The cooperative paging and WUS module 908 may be implemented via hardware, software, or combinations thereof. For example, the cooperative paging and WUS module 908 may be implemented as a processor, circuit, and/or instructions 906 stored in the memory 904 and executed by the processor 902.

The cooperative paging and WUS module 908 may be used for various aspects of the present disclosure, for example, aspects of FIGS. 2-7 and 10-11. In some aspects, the cooperative paging and WUS module 908 may be configured to receive, from at least one of a first sidelink UE or a second sidelink UE, a request to receive via a sidelink communication from the first sidelink UE, at least one of a paging signal associated with the second sidelink UE or a wakeup signal associated with the second sidelink UE. The cooperative paging and WUS module 908 may be configured to transmit, to the first sidelink UE, the at least one of the paging signal associated with the second sidelink UE or the wakeup signal associated with the second sidelink UE.

Additionally or alternatively, the cooperative paging and WUS module 908 can be implemented in any combination of hardware and software, and may, in some implementations, involve, for example, processor 902, memory 904, instructions 906, transceiver 910, and/or modem 912.

As shown, the transceiver 910 may include the modem subsystem 912 and the RF unit 914. The transceiver 910 can be configured to communicate bi-directionally with other devices, such as the UEs 115 and/or 600. The modem subsystem 912 may be configured to modulate and/or encode data according to a MCS, e.g., a LDPC coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or UE 600. The RF unit 914 may be further configured to perform analog beamforming in conjunction with the digital beamforming. Although shown as integrated together in transceiver 910, the modem subsystem 912 and/or the RF unit 914 may be separate devices that are coupled together at the BS 900 to enable the BS 900 to communicate with other devices.

The RF unit 914 may provide the modulated and/or processed data, e.g. data packets (or, more generally, data messages that may contain one or more data packets and other information), to the antennas 916 for transmission to one or more other devices. This may include, for example, a configuration indicating a plurality of sub-slots within a slot according to aspects of the present disclosure. The antennas 916 may further receive data messages transmitted from other devices and provide the received data messages for processing and/or demodulation at the transceiver 910. The antennas 916 may include multiple antennas of similar or different designs in order to sustain multiple transmission links.

In some instances, the BS 900 can include multiple transceivers 910 implementing different RATs (e.g., NR and LTE). In some instances, the BS 900 can include a single transceiver 910 implementing multiple RATs (e.g., NR and LTE). In some instances, the transceiver 910 can include various components, where different combinations of components can implement RATs.

In some aspects, the processor 902 may be coupled to the memory 904, the cooperative paging and WUS module 908, and/or the transceiver 910. The processor 902 may execute OS code stored in the memory 904 to control and/or coordinate operations of the cooperative paging and WUS module 908, and/or the transceiver 910. In some aspects, the processor 902 may be implemented as part of the cooperative paging and WUS module 908. In some aspects, the processor 902 is configured to transmit via the transceiver 910, to a UE, an indicator indicating a configuration of sub-slots within a slot.

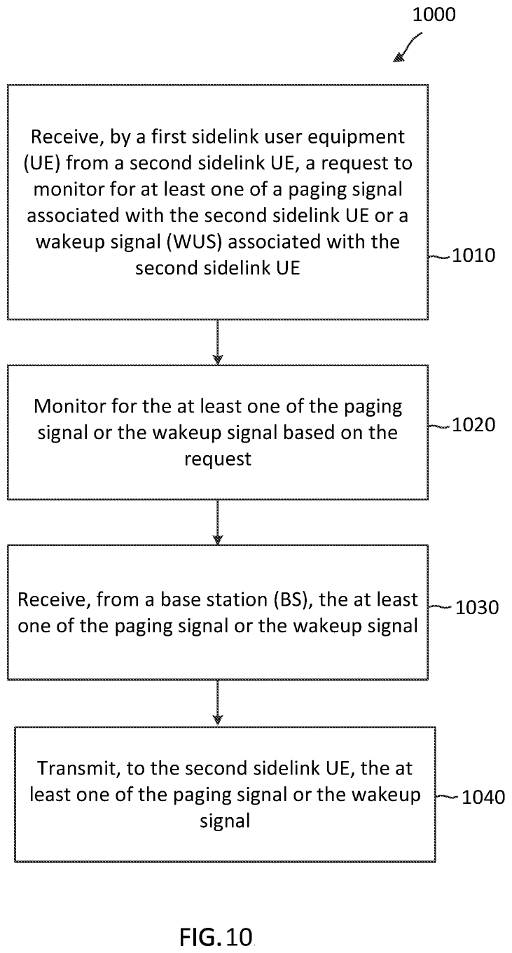

FIG. 10 is a flow diagram of a communication method 1000 according to some aspects of the present disclosure. Aspects of the method 1000 can be executed by a computing device (e.g., a processor, processing circuit, and/or other suitable component) of a wireless communication device or other suitable means for performing the aspects. For example, a wireless communication device, such as the UE 115 or UE 800, may utilize one or more components, such as the processor 802, the memory 804, the cooperative paging and WUS module 808, the transceiver 810, the modem 812, and the one or more antennas 816, to execute aspects of method 1000. The method 1000 may employ similar mechanisms as in the networks 100 and 200 and the aspects and actions described with respect to FIGS. 2-7. As illustrated, the method 1000 includes a number of enumerated aspects, but the method 1000 may include additional aspects before, after, and in between the enumerated aspects. In some aspects, one or more of the enumerated aspects may be omitted or performed in a different order.

At 1010, the method 1000 includes a first sidelink UE (e.g., the UE 115 or the UE 800) receiving, from a second sidelink UE, a request to monitor for at least one of a paging signal associated with the second sidelink UE or a wakeup signal (WUS) associated with the second sidelink UE. In this regard, the first sidelink UE may receive the request from the second sidelink UE via a physical sidelink control channel (PSCCH), a physical sidelink shared channel (PSSCH), sidelink control information (SCI), or other suitable communication. In some aspects, the first sidelink UE and the second sidelink UE may be sidelink UEs in communication with each other. The first sidelink UE and the second sidelink UE may be included in a sidelink group. The sidelink group may include any number of UEs (e.g., two UEs, three UEs, four UEs, etc.). The sidelink group may include one or more UE group members and one or more UE group leaders. In some aspects, the sidelink group may include a single UE group leader and one or more UE group members. In some aspects, the first sidelink UE may be a UE group leader. The UE group leader may monitor for a paging signal and/or a WUS transmitted by a BS that is intended for one or more of the UE group member(s) and forward the paging signal and/or the WUS to the intended UE group member(s). Aspects of the present disclosure may enable power consumption reduction in the UE group member(s) by allowing the UE group leader to monitor for the paging signal and/or the WUS while the UE group member(s) remain in a low power mode (e.g., a sleep mode).

In some aspects, the second sidelink UE may be a UE group member. The request from the second sidelink UE to monitor for a paging signal and/or a WUS associated with the second sidelink UE may include information regarding the paging signal and/or WUS, such as an indicator indicating a paging monitoring occasion associated with the second sidelink UE, an indicator indicating a WUS monitoring occasion associated with the second sidelink UE, a threshold value associated with a sidelink signal quality, and/or an identifier associated with the second sidelink UE. The information included in the request from the second sidelink UE may be used by the first sidelink UE to determine a response to the request. For example, the first sidelink UE may determine whether to monitor for the paging signal and/or the WUS associated with the second sidelink UE based on whether the first sidelink UE and the second sidelink UE have the same paging monitoring occasion and/or the same WUS monitoring occasion as described above with reference to FIG. 3. The second sidelink UE may transmit the request including information associated with the second sidelink UE's paging monitoring occasion and/or WUS monitoring occasion. The information associated with the second sidelink UE's paging monitoring occasion and/or WUS monitoring occasion may include periodicity, timing offset (e.g., timing offset from the beginning of a DRX cycle) and/or time duration of the second sidelink UE's paging monitoring occasion (e.g., time during which the UE monitors for paging) and/or WUS monitoring occasion (e.g., time during which the UE monitors for a WUS). When the first sidelink UE and the second sidelink UE have the same paging monitoring occasion and/or WUS monitoring occasion, the first sidelink UE may transmit a response message to the second sidelink UE indicating that the first sidelink UE will monitor for at least one of a paging signal associated with the second sidelink UE or a WUS associated with the second sidelink UE. The first sidelink UE may respond to the request from the second sidelink UE indicating that the second sidelink UE is a UE group member and the first sidelink UE is a UE group leader. In some aspects, when the first sidelink UE and the second sidelink UE do not have the same paging monitoring occasion and/or WUS monitoring occasion, the first sidelink UE may transmit a response message to the second sidelink UE indicating that the first sidelink UE will not monitor for a paging signal associated with the second sidelink UE or a WUS associated with the second sidelink UE. The first sidelink UE may receive requests for monitoring paging signals/WUSs from multiple UEs. The first sidelink UE may respond to the requests from multiple UEs indicating whether the requesting UEs will be UE group members. For example, if the requesting UE indicates a different paging monitoring occasion periodicity and/or a different WUS monitoring occasion periodicity than the paging monitoring occasion periodicity and/or WUS monitoring occasion periodicity of the first sidelink UE, the first sidelink UE may respond to the request indicating that the first sidelink UE will not monitor for the paging signal and/or the WUS associated with the requesting UE. In this case, the request UE (e.g., the second sidelink UE) may transmit a request to a UE different from the first sidelink UE to monitor for a paging signal and/or a WUS associated with the second sidelink UE.

In some aspects, the first sidelink UE may determine whether to monitor for the paging signal and/or the WUS associated with the second sidelink UE based on whether the first sidelink UE and the second sidelink UE have an overlapping paging monitoring occasion and/or WUS monitoring occasion as described above with reference to FIG. 4. The first sidelink UE and the second sidelink UE may have any amount of overlapping paging monitoring occasion and/or WUS monitoring occasion. The second sidelink UE may transmit the request including information associated with the second sidelink UE's paging monitoring occasion and/or WUS monitoring occasion. The information associated with the second sidelink UE's paging monitoring occasion and/or WUS monitoring occasion may include periodicity, timing offset (e.g., timing offset from the beginning of a DRX cycle) and/or time duration of the second sidelink UE's paging monitoring occasion and/or WUS monitoring occasion. When the first sidelink UE and the second sidelink UE have an overlap in the paging monitoring occasion and/or WUS monitoring occasion, the first sidelink UE may transmit a response message to the second sidelink UE indicating that the first sidelink UE will monitor for at least one of a paging signal associated with the second sidelink UE or a WUS associated with the second sidelink UE. For example, the paging monitoring occasion of the first sidelink UE and the paging monitoring occasion of the second sidelink UE may have a time period (e.g., an overlapping time period) when the paging monitoring occasions occur simultaneously. The WUS monitoring occasion of the first sidelink UE and the WUS monitoring occasion of the second sidelink UE may have a time period (e.g., an overlapping time period) when the WUS monitoring occasions occur simultaneously. The first sidelink UE may respond to the second sidelink UE's request indicating that the second sidelink UE is a UE group member and the first sidelink UE is a UE group leader. In some aspects, when the first sidelink UE and the second sidelink UE do not have an overlap in the paging monitoring occasion and/or WUS monitoring occasion, the first sidelink UE may transmit a response message to the second sidelink UE indicating that the first sidelink UE will not monitor for a paging signal associated with the second sidelink UE or a WUS associated with the second sidelink UE.

In some aspects, the first sidelink UE may determine whether to monitor for the paging signal and/or WUS associated with the second sidelink UE based on whether the first sidelink UE and the second sidelink UE have different paging monitoring occasions (e.g., the paging monitoring occasion(s) for the first sidelink UE are not aligned and do not overlap with the paging monitoring occasion(s) for the second sidelink UE) and/or WUS monitoring occasions (e.g., the WUS monitoring occasion(s) for the first sidelink UE are not aligned and do not overlap with the WUS monitoring occasion(s) for the second sidelink UE) as described above with reference to FIG. 5. The second sidelink UE may transmit the request including information associated with the second sidelink UE's paging monitoring occasion and/or WUS monitoring occasion. The information associated with the second sidelink UE's paging monitoring occasion and/or WUS monitoring occasion may include periodicity, timing offset (e.g., timing offset from the beginning of a DRX cycle) and/or time duration of the second sidelink UE's paging monitoring occasion and/or WUS monitoring occasion. When the first sidelink UE and the second sidelink UE have different paging monitoring occasions and/or WUS monitoring occasions, the first sidelink UE may transmit a response message to the second sidelink UE indicating that the first sidelink UE will monitor for at least one of a paging signal associated with the second sidelink UE or a WUS associated with the second sidelink UE.

In some instances, the paging monitoring occasion of the first sidelink UE and the paging monitoring occasion of the second sidelink UE may occur during different time periods. For example, a paging monitoring occasion of the second sidelink UE may occur immediately before and/or immediately after a paging monitoring occasion of the first sidelink UE. The paging monitoring occasions of the first sidelink UE and the second sidelink UE may be contiguous (e.g., adjacent) in time. The paging monitoring occasions of the first sidelink UE and the second sidelink UE may be non-contiguous (e.g., spaced apart) in time.

The WUS monitoring occasion of the first sidelink UE and the WUS monitoring occasion of the second sidelink UE may occur during different time periods. The WUS monitoring occasion of the second sidelink UE may occur immediately before and/or immediately after the WUS monitoring occasion of the first sidelink UE. The WUS monitoring occasions of the first sidelink UE and the second sidelink UE may be contiguous (e.g., adjacent) in time. The WUS monitoring occasions of the first sidelink UE and the second sidelink UE may be non-contiguous (e.g., spaced apart) in time.

In some instances, the first sidelink UE may respond to the request from the second indicating that the second sidelink UE is a UE group member and the first sidelink UE is a UE group leader. In some aspects, when the first sidelink UE and the second sidelink UE do not have aligned, overlapping, and/or contiguous (e.g., adjacent) paging monitoring occasions and/or WUS monitoring occasions (e.g., the paging monitoring occasions and/or the WUS monitoring occasions are non-contiguous), the first sidelink UE may transmit a response message to the second sidelink UE indicating that the first sidelink UE will not monitor for a paging signal associated with the second sidelink UE or a WUS associated with the second sidelink UE.

When the paging monitoring occasion and/or WUS monitoring occasion of the first sidelink UE is the same as the second sidelink UE, overlaps with the second sidelink UE, and/or is contiguous to the second sidelink UE, the first sidelink UE may monitor for the paging signal and/or WUS intended for the first sidelink UE as well as the paging signal and/or WUS intended for the second sidelink UE. The first sidelink UE may monitor for the paging signal and/or WUS intended for the first sidelink UE as well as the paging signal and/or WUS intended for the second sidelink UE without entering a sleep mode. Although the example discussed above describes a single UE group leader monitoring for the paging signal and/or WUS intended for a single UE group member (e.g., the second sidelink UE), the UE group leader (e.g., the first sidelink UE) may monitor for the paging signal and/or WUS intended for the UE group leader and the paging signals and/or WUSs intended for multiple UE group members. In some instances, after monitoring for the paging signal and/or WUS intended for the UE group leader and multiple UE group members, the UE group leader may enter a sleep mode. The UE group leader may wakeup from the sleep mode based on a DRX cycle period of the UE group leader.

In some aspects, the UE group leader (e.g., the first sidelink UE) may be chosen based on any suitable criteria. In some instances, the UE group leader may be chosen based on a power capacity of the UE. Since monitoring for paging signals and/or WUSs for the UE group leader and one or more UE group members may increase power consumption in the UE group leader as compared to monitoring paging signals and/or WUSs for the UE group leader only, the UE group leader may be chosen based on having a higher power capacity (e.g., a larger battery capacity, a longer remaining battery life, AC line power connection) than one or more of the UE group members. In some aspects, the UE group leader may change from the first sidelink UE to another UE over time. For example, the UE group leader may change from the first sidelink UE to the second sidelink UE or another UE. The UE group leader may change from the first sidelink UE to another UE in the sidelink UE group or to another UE that joins the sidelink UE group. In some aspects, the UE group leader may change from the first sidelink UE to another UE based on a power capacity of the other UEs. For example, when the power capacity of the first sidelink UE (e.g., the UE group leader) falls below a threshold, the UE group leader may change from the first sidelink UE to another UE based on a power capacity of the other UE. In some aspects, the UE group leader may change based on a time sharing scheme. For example, each member of the sidelink UE group may act as the UE group leader for a period of time. When the time period has expired another UE in the group may become the UE group leader.

In some aspects, the first sidelink UE (e.g., the UE group leader) may monitor for the paging signal and/or the WUS signal of the second sidelink UE (e.g., a UE group member) based on a sidelink signal quality associated with the second sidelink UE satisfying a threshold value. In some aspects, the second sidelink UE may transmit an indicator indicating a sidelink signal quality threshold value to the first sidelink UE. In this regard, the second sidelink UE may transmit the threshold value to the first sidelink UE via a sidelink radio resource control (SL-RRC) message, a physical sidelink control channel (PSCCH), a physical sidelink shared channel (PSSCH), sidelink control information (SCI), or other suitable communication. In some aspects, the first sidelink UE may receive the threshold value from the second sidelink UE via the request to monitor for the paging signal and/or the WUS at action 1010. In some aspects, the threshold value may be stored (e.g., hard coded) in the first sidelink UE. The first sidelink UE may store a table of threshold values from which the first sidelink UE may choose from. In some aspects, the threshold value may be stored (e.g., hard coded) in the second sidelink UE and transmitted to the first sidelink UE.

When the sidelink signal quality associated with the second sidelink UE satisfies the threshold value, the signal quality between the second sidelink UE and the first sidelink UE may be suitable for the first sidelink UE to monitor for the paging signal and/or the WUS and transmit the paging signal and/or the WUS to the second sidelink UE. The sidelink signal quality associated with the second sidelink UE may be determined using any suitable method. For example, the first sidelink UE may measure the sidelink signal quality based on communications from the second sidelink UE. For example, the second sidelink UE may transmit a reference signal (e.g., a demodulation reference signal (DMRS), a sidelink channel state information reference signal (SL CSI-RS), synchronization signal block (SSB), the request message, or any suitable communication to the first sidelink UE. The first sidelink UE may measure a signal-to-interference-plus-noise ratio (SINR), a reference signal received power (RSRP), and/or a received signal strength indicator (RSSI) associated with the sidelink communication from the second sidelink UE to the first sidelink UE. The first sidelink UE may compare the measured sidelink signal quality to the sidelink signal quality threshold.

Additionally or alternatively, the first sidelink UE (e.g., the UE group leader) may monitor for the paging signal or the WUS signal associated with the second sidelink UE (e.g., a UE group member) based on a sidelink signal quality associated with the first sidelink UE satisfying a threshold value. In some aspects, the first sidelink UE may transmit an indicator indicating a sidelink signal quality threshold value to the second sidelink UE. In this regard, the first sidelink UE may transmit the threshold value to the second sidelink UE via a sidelink radio resource control (SL-RRC) message, a physical sidelink control channel (PSCCH), a physical sidelink shared channel (PSSCH), sidelink control information (SCI), or other suitable communication. In some aspects, the threshold value may be stored (e.g., hard coded) in the second sidelink UE. In some aspects, the threshold value may be stored (e.g., hard coded) in the first sidelink UE and transmitted to the second sidelink UE.

When the sidelink signal quality associated with the first sidelink UE satisfies the threshold value, the signal quality between the first sidelink UE and the second sidelink UE may be suitable for the first sidelink UE to monitor for the paging signal and/or the WUS and transmit the paging signal and/or the WUS to the second sidelink UE. The sidelink signal quality associated with the first sidelink UE may be determined using any suitable method. For example, the second sidelink UE may measure the quality of the sidelink signal based on communications from the first sidelink UE. For example, the first sidelink UE may transmit a reference signal (e.g., a demodulation reference signal (DMRS), a sidelink channel state information reference signal (SL CSI-RS), a synchronization signal block (SSB), or any suitable communication to the second sidelink UE. The second sidelink UE may measure a signal-to-interference-plus-noise ratio (SINR), a reference signal received power (RSRP), and/or a received signal strength indicator (RSSI) associated with the sidelink communication from the first sidelink UE to the second sidelink UE. The second sidelink UE may transmit an indicator to the first sidelink UE indicating whether the sidelink signal quality associated with the first sidelink UE satisfies the threshold value (e.g., the measured signal quality is greater than the threshold value). Additionally or alternatively, the second sidelink UE may transmit a report (e.g., CSI-RS report) to the first sidelink UE indicating the sidelink signal quality associated with the communication from the first sidelink UE. The first sidelink UE may determine whether the sidelink signal quality associated with the first sidelink UE satisfies the threshold value based on the report.

In some aspects, the first sidelink UE (e.g., the UE group leader) may monitor for the paging signal and/or the WUS signal of the second sidelink UE (e.g., a UE group member) based on a signal quality between the first sidelink UE and a BS (e.g., a Uu link quality) satisfying a threshold value. In some aspects, the Uu link may be a directional beam between the first sidelink UE and the BS. In some aspects, the BS may be unaware of the first sidelink UE monitoring for the paging signal and/or the WUS signal of the second sidelink UE. In this case, the threshold value may be stored (e.g., hard coded) in the first sidelink UE. In some aspects, the threshold value may be stored (e.g., hard coded) in the second sidelink UE and transmitted to the first sidelink UE. In this regard, the second sidelink UE may transmit the Uu threshold value to the first sidelink UE via a sidelink radio resource control (SL-RRC) message, a physical sidelink control channel (PSCCH), a physical sidelink shared channel (PSSCH), sidelink control information (SCI), or other suitable communication. In some aspects, the first sidelink UE may receive the Uu signal quality threshold value from the second sidelink UE via the request to monitor for the paging signal and/or the WUS at action 1010.

When the Uu signal quality associated with communications between the first sidelink UE and the BS satisfies the threshold value, the signal quality between the BS and the first sidelink UE may be suitable for the first sidelink UE to monitor for the paging signal and/or the WUS from the BS and transmit the paging signal and/or the WUS to the second sidelink UE. The Uu signal quality associated with the communications between the BS and the first sidelink UE may be determined using any suitable method. For example, the first sidelink UE may measure the quality of the Uu signal based on downlink communications from the BS. For example, the first sidelink UE may receive a reference signal (e.g., a demodulation reference signal (DMRS), a channel state information reference signal (CSI-RS), a sounding reference signal (SRS)), or any suitable communication from the BS. The first sidelink UE may measure a signal-to-interference-plus-noise ratio (SINR), a reference signal received power (RSRP), and/or a received signal strength indicator (RSSI) associated with the communication from the BS to the first sidelink UE. The first sidelink UE may determine whether to monitor for a paging signal and/or a WUS associated with the second sidelink UE based on whether the Uu signal quality associated with communications between the first sidelink UE and the BS satisfies the threshold value. For example, the first sidelink UE may monitor for a paging signal and/or a WUS associated with the second sidelink UE when the Uu signal quality associated with communications between the first sidelink UE and the BS satisfies the threshold value (e.g., the measured signal quality is greater than the threshold value). The first sidelink UE may not monitor for a paging signal and/or a WUS associated with the second sidelink UE when the Uu signal quality associated with communications between the first sidelink UE and the BS does not satisfy the threshold value (e.g., the measured signal quality is less than the threshold value).

In some aspects, the first sidelink UE may periodically determine the Uu signal quality. The Uu quality may change over time based on channel conditions and/or distance between the BS and the first sidelink UE. The first sidelink UE may periodically determine the Uu signal quality to determine whether the first sidelink UE should monitor for a paging signal and/or a WUS associated with the second sidelink UE. For example, the first sidelink UE may discontinue monitoring for a paging signal and/or a WUS associated with the second sidelink UE when the signal quality between the first sidelink UE and the BS drops below the threshold level. in this case, the first sidelink UE may transmit an indicator to the second sidelink UE indicating that the first sidelink UE will discontinue monitoring for a paging signal and/or a WUS associated with the second sidelink UE.

At action 1020, the method 1000 includes the first sidelink UE monitoring for at least one of the paging signal or the wakeup signal associated with the second sidelink UE. The first sidelink UE may monitor for the paging signal or the wakeup signal associated with the second sidelink UE based on the request received from the second sidelink UE at action 1010. In this regard, the first sidelink UE may monitor for paging control channel (PCCH) communications, physical downlink control channel (PDCCH) communications, physical downlink shared channel (PDSCH) communications, and/or physical broadcast channel (PBCH) communications including the paging signal and/or the WUS associated with the second sidelink UE. The first sidelink UE may monitor for the paging signal or the wakeup signal associated with the second sidelink UE based on resources indicated in downlink control information (e.g., DCI format 1_0) transmitted by the BS to the second sidelink UE and transmitted to the first sidelink UE at action 1010.

At 1030, the method 1000 includes the first sidelink UE (e.g., the UE 115 or the UE 800) receiving from the BS the paging signal and/or the WUS associated with the second sidelink UE. In this regard, the first sidelink UE may receive the paging signal and/or the WUS associated with the second sidelink UE via a physical downlink shared channel (PDSCH), a paging transport channel (PCH), and/or a paging control channel (PCCH). In some aspects, the BS may be unaware that the first sidelink UE is monitoring for and receiving the paging signal and/or the WUS associated with the second sidelink UE. The first sidelink UE may monitor and receive (e.g., decode) the paging signal and/or the WUS associated with the second sidelink UE based on information received from the second sidelink UE at action 1010. For example, the first sidelink UE may receive the paging signal associated with the second sidelink UE based on the UE identifier and the paging monitoring occasion associated with the second sidelink UE. The first sidelink UE may decode the paging signal intended for the second sidelink UE using the second sidelink UE's ID during the paging monitoring occasion associated with the second sidelink UE. The first sidelink UE may receive the WUS associated with the second sidelink UE based on the UE identifier and the WUS monitoring occasion associated with the second sidelink UE. For example, the first sidelink UE may decode the WUS intended for the second sidelink UE using the second sidelink UE's ID during the WUS monitoring occasion associated with the second sidelink UE.

At 1040, the method 1000 includes the first sidelink UE (e.g., the UE 115 or the UE 800) transmitting, to the second sidelink UE, the paging signal and/or the WUS associated with the second sidelink UE. In this regard, when the first sidelink UE decodes the paging signal and/or the WUS associated with the second sidelink UE, the first sidelink UE may transmit an indicator to the second sidelink UE indicating whether the second sidelink UE should wake up. Additionally or alternatively, the first sidelink UE may transmit an indicator to the second sidelink UE indicating whether the second sidelink UE should enter or remain in a sleep mode. For example, the first sidelink UE may transmit a codepoint indicator to the second sidelink UE. The codepoint indicator may be a single bit indicating whether the second sidelink UE should wake up (e.g., a codepoint value of 1) or enter/remain in sleep mode (e.g., a codepoint value of 0).

Additionally or alternatively, the first sidelink UE may receive the paging signal and/or the WUS associated with the second sidelink UE from the BS and transmit (e.g., forward) the paging signal and/or WUS to the second sidelink UE without decoding the paging signal and/or the WUS. For example, the first sidelink UE may not receive or be aware of the ID associated with the second sidelink UE. The first sidelink UE may function as a repeater node receiving the paging signal and/or the WUS from the BS and transmitting (e.g., repeating) the paging signal and/or the WUS over a sidelink communication (e.g., a PSCCH, a PSSCH, SCI, etc.) without decoding the paging signal and/or the WUS associated with the second sidelink UE. The second sidelink UE may monitor for sidelink communications forwarded by the first sidelink UE from the BS and decode the paging signal and/or the WUS intended for the second sidelink UE. The second sidelink UE may monitor for sidelink communications forwarded by the first sidelink UE from the BS based on resources indicated in downlink control information (e.g., DCI format 1_0) transmitted by the BS to the second sidelink UE.

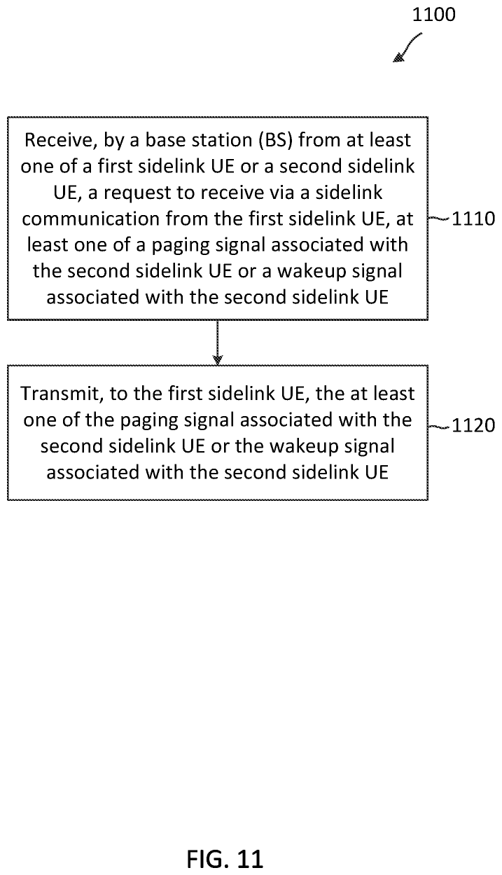

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the aspects. For example, a wireless communication device, such as the BS 105 or BS 900, may utilize one or more components, such as the processor 902, the memory 904, the cooperative paging and WUS module 908, the transceiver 910, the modem 912, and the one or more antennas 916, to execute aspects of method 1100. The method 1100 may employ similar mechanisms as in the networks 100 and 200 and the aspects and actions described with respect to FIGS. 2-7. As illustrated, the method 1100 includes a number of enumerated aspects, but the method 1100 may include additional aspects before, after, and in between the enumerated aspects. In some aspects, one or more of the enumerated aspects may be omitted or performed in a different order.

At 1110, the method 1100 includes a base station (e.g., the BS 105 or the BS 900) receiving, from a first sidelink UE (e.g., a UE group leader) or a second sidelink UE (e.g., a UE group member), a request to receive via a sidelink communication from the first sidelink UE, at least one of a paging signal associated with the second sidelink UE or a wakeup signal associated with the second sidelink UE. In this regard, the BS may receive the request from the first sidelink UE and/or the second sidelink UE via a physical uplink control channel (PUCCH), a physical uplink shared channel (PUSCH), uplink control information (UCI), or other suitable communication. In some aspects, the first sidelink UE and the second sidelink UE may be sidelink UEs in communication with each other. The first sidelink UE and the second sidelink UE may be included in a sidelink group. The sidelink group may include any number of UEs (e.g., two UEs, three UEs, four UEs, etc.). The sidelink group may include one or more UE group members and one or more UE group leaders. In some aspects, the sidelink group may include a single UE group leader (e.g., the first sidelink UE) and one or more UE group members (e.g., the second sidelink UE). In some aspects, the first sidelink UE may be a UE group leader. The UE group leader may monitor for a paging signal and/or a WUS transmitted by a BS that is intended for one or more of the UE group member(s) and transmit (e.g., forward) the paging signal and/or the WUS to the intended UE group member(s). Aspects of the present disclosure may enable power consumption reduction in the UE group member(s) by allowing the UE group leader to monitor for the paging signal and/or the WUS while the UE group member(s) remain in a low power mode (e.g., a sleep mode).

In some aspects, the second sidelink UE may be a UE group member. The second sidelink UE and the first sidelink UE (e.g., the UE group leader) may form a sidelink group. The first sidelink UE may form the sidelink group and transmit the request to the BS indicating the first sidelink UE is the group leader and the group members includes the second sidelink UE. In some aspects, the BS may form the sidelink group and select the sidelink group leader and the sidelink group members. The first sidelink UE may form the group as described above with reference to action 1010 of method 1000. For example, the first sidelink UE may form the group based on the first sidelink UE and the second sidelink UE having the same, overlapping, or consecutive WUS monitoring occasions and/or paging monitoring occasions. When the paging monitoring occasion and/or WUS monitoring occasion of the first sidelink UE is the same as the second sidelink UE, overlaps with the second sidelink UE, and/or is contiguous to the second sidelink UE, the first sidelink UE may monitor for the paging signal and/or WUS intended for the first sidelink UE as well as the paging signal and/or WUS intended for the second sidelink UE. The first sidelink UE may monitor for the paging signal and/or WUS intended for the first sidelink UE as well as the paging signal and/or WUS intended for the second sidelink UE without entering a sleep mode. In some aspects, the first sidelink UE may enter a sleep mode (e.g., DRX off state) during a DRX cycle. The first sidelink UE may monitor for the paging signal and/or WUS intended for the first sidelink UE as well as the paging signal and/or WUS intended for the second sidelink UE during a DRX on state.

The WUS monitoring occasion of the first sidelink UE and the WUS monitoring occasion of the second sidelink UE may occur during different time periods. The WUS monitoring occasion of the second sidelink UE may occur immediately before and/or immediately after the WUS monitoring occasion of the first sidelink UE. The WUS monitoring occasions of the first sidelink UE and the second sidelink UE may be contiguous (e.g., adjacent) in time. In some aspect, the WUS monitoring occasions of the first sidelink UE and the second sidelink UE may be non-contiguous (e.g., spaced apart) in time.

In some instances, the first sidelink UE may respond to the request from the second sidelink UE indicating that the second sidelink UE is a UE group member and the first sidelink UE is a UE group leader. In some aspects, when the first sidelink UE and the second sidelink UE do not have aligned, overlapping, and/or contiguous (e.g., adjacent) paging monitoring occasions and/or WUS monitoring occasions (e.g., the paging monitoring occasions and/or the WUS monitoring occasions are non-contiguous), the first sidelink UE may transmit a response message to the second sidelink UE indicating that the first sidelink UE will not monitor for a paging signal associated with the second sidelink UE or a WUS associated with the second sidelink UE.

Although the example discussed above describes a single UE group leader monitoring for the paging signal and/or WUS intended for a single UE group member (e.g., the second sidelink UE), the UE group leader (e.g., the first sidelink UE) may monitor for the paging signal and/or WUS intended for the UE group leader and the paging signals and/or WUSs intended for multiple UE group members. In some instances, after monitoring for the paging signal and/or WUS intended for the UE group leader and multiple UE group members, the UE group leader may enter a sleep mode. The UE group leader may wakeup from the sleep mode based on a DRX cycle period of the UE group leader.

Additionally or alternatively, the first sidelink UE (e.g., the UE group leader) may form the group based on a sidelink signal quality associated with the second sidelink UE satisfying a threshold value. In some aspects, the second sidelink UE may transmit an indicator indicating a sidelink signal quality threshold value to the first sidelink UE. In this regard, the second sidelink UE may transmit the threshold value to the first sidelink UE via a sidelink radio resource control (SL-RRC) message, a physical sidelink control channel (PSCCH), a physical sidelink shared channel (PSSCH), sidelink control information (SCI), or other suitable communication. When the sidelink signal quality associated with the second sidelink UE satisfies the threshold value, the second sidelink UE may be considered a group member. The BS may receive an indication from the first sidelink UE that the second sidelink UE is a group member. The sidelink signal quality associated with the second sidelink UE may be determined using any suitable method, for example, the methods described above at action 1010 of method 1000.

In some aspects, the BS may assist in forming the sidelink group. In this regard, the BS may receive from the first sidelink UE an indicator indicating which sidelink UEs among sidelink UEs in proximity to the first sidelink UE has the highest sidelink signal quality. For example, the first sidelink UE may determine that the second sidelink UE has the highest sidelink signal quality among sidelink UEs in proximity to the first sidelink UE. The BS may receive an indicator (e.g., a report) indicating an identifier of the second sidelink UE that has the highest sidelink signal quality among sidelink UEs in proximity to the first sidelink UE. The second sidelink UE may be considered a group member based on having the highest sidelink signal quality.

In some aspects, the BS may determine the number of sidelink UEs that form the sidelink group. The BS may transmit the number of sidelink UEs that form the sidelink group to the first sidelink UE via a PDCCH communication, a PDSCH communication, an RRC message, or downlink control information (DCI). The first sidelink UE may determine the sidelink signal quality among sidelink UEs in proximity to the first sidelink UE. The UE may select the number of sidelink UEs indicated by the BS that have the highest sidelink signal quality. The BS may receive an indicator (e.g., a report) indicating the identifiers of the sidelink UEs that have the highest sidelink signal quality. The identifiers of the sidelink UEs that have the highest sidelink signal quality may include the second sidelink UE. The number of sidelink UEs indicated by the BS may be considered group members based on having the highest sidelink signal quality.

Additionally or alternatively, the BS may transmit a sidelink signal quality threshold value to the first sidelink UE. In this regard, the BS may transmit the sidelink signal quality threshold value to the first sidelink UE via a PDCCH communication, a PDSCH communication, an RRC message, or DCI. The first sidelink UE may determine the sidelink signal quality among sidelink UEs in proximity to the first sidelink UE. The first sidelink UE may select all sidelink UEs having a sidelink signal quality that satisfies the sidelink signal quality threshold value indicated by the BS. The BS may receive an indicator (e.g., a report) indicating the identifiers of the sidelink UEs that have a sidelink signal quality that satisfies the sidelink signal quality threshold value. The identifiers of the sidelink UEs that have a sidelink signal quality that satisfies the sidelink signal quality threshold value may include the second sidelink UE. The sidelink UEs that have a sidelink signal quality that satisfies the sidelink signal quality threshold value may be considered group members.

At action 1120, the method 1100 may include the BS transmitting, to the first sidelink UE, the paging signal associated with the second sidelink UE or the wakeup signal associated with the second sidelink UE. The BS may transmit the paging signal and/or the wakeup signal associated with the second sidelink UE to the first sidelink UE based on the request received by the BS at action 1110. In this regard, the BS may transmit the paging signal and/or the wakeup signal to the first sidelink UE via a paging control channel (PCCH) communications, a physical downlink control channel (PDCCH) communications, a physical downlink shared channel (PDSCH) communications, and/or a physical broadcast channel (PBCH) communications.

The BS may transmit the paging signal and/or the wakeup signal intended for the second sidelink UE and other sidelinks UEs in the group to the first sidelink UE. The first sidelink UE may monitor for the paging signal and/or the wakeup signal associated with the second sidelink UE based on resources indicated in downlink control information (e.g., DCI format 1_0) transmitted by the BS to the first sidelink UE or transmitted to the second sidelink UE and forwarded to the first sidelink UE. The first sidelink UE may monitor for the paging signal or the wakeup signal associated with the second sidelink UE during the second sidelink UE's paging monitoring occasion and/or WUS monitoring occasion. The first sidelink UE may monitor and receive (e.g., decode) the paging signal and/or the WUS associated with the second sidelink UE based on information received from the second sidelink UE. For example, the first sidelink UE may receive the paging signal associated with the second sidelink UE based on the UE identifier and the paging monitoring occasion associated with the second sidelink UE. The first sidelink UE may decode the paging signal intended for the second sidelink UE using the second sidelink UE's ID during the paging monitoring occasion associated with the second sidelink UE. The first sidelink UE may receive the WUS associated with the second sidelink UE based on the UE identifier and the WUS monitoring occasion associated with the second sidelink UE. For example, the first sidelink UE may decode the WUS intended for the second sidelink UE using the second sidelink UE's ID during the WUS monitoring occasion associated with the second sidelink UE. The first sidelink UE may transmit the paging signal and/or the WUS to the second sidelink UE after decoding the paging signal and/or the WUS.

Additionally or alternatively, the BS may combine the paging signal and/or the WUS intended for the second sidelink UE with the paging signal and/or the WUS intended for the first sidelink UE (e.g., the UE group leader). In some aspects, the BS may combine the paging signal and/or the WUS intended for each sidelink UE group member, including the second sidelink UE, with the paging signal and/or the WUS intended for the first sidelink UE (e.g., the UE group leader). In this case, the paging signal and/or the WUS transmitted to the first sidelink UE may include the identifier associated with the first sidelink UE, the second sidelink UE and/or identifiers associated with other sidelink UEs in the sidelink group (e.g., other sidelink UE group members). In some aspects, the BS may transmit a bitmap to the first sidelink UE indicating which sidelink UEs in the group should receive a paging signal and/or a WUS. The bitmap may include one or more bits corresponding to each of the sidelink UEs in the group. The state of the bit (e.g., 0 or 1) may indicate whether the corresponding UE should receive the paging signal and/or the WUS. After receiving the paging signal and/or the WUS indicating sidelink group members (e.g., the bitmap), the first sidelink UE may transmit the paging signal and/or the WUS via a unicast message to each of the sidelink group members indicated by the bitmap and/or the identifiers associated with the sidelink UEs in the sidelink group. Additionally or alternatively, the first sidelink UE may groupcast and/or broadcast the paging signal and/or the WUS to the sidelink group members indicated by the combined paging signal and/or WUS received from the BS.

Further aspects of the present disclosure include the following:
Aspect 1 includes a method of wireless communication performed by a first sidelink user equipment (UE), the method comprising receiving, from a second sidelink UE, a request to monitor for at least one of a paging signal associated with the second sidelink UE or a wakeup signal (WUS) associated with the second sidelink UE; monitoring for the at least one of the paging signal or the wakeup signal based on the request; receiving, from a base station (BS), the at least one of the paging signal or the wakeup signal; and transmitting, to the second sidelink UE, the at least one of the paging signal or the wakeup signal.
Aspect 2 includes the method of aspect 1, wherein at least one of a paging monitoring occasion associated with the first sidelink UE is a same paging monitoring occasion associated with the second sidelink UE; or a WUS monitoring occasion associated with the first sidelink UE is a same WUS monitoring occasion associated with the second sidelink UE.
Aspect 3 includes the method of any of aspects 1-2, wherein at least one of a paging monitoring occasion associated with the first sidelink UE overlaps a paging monitoring occasion associated with the second sidelink UE; or a WUS monitoring occasion associated with the first sidelink UE overlaps a WUS monitoring occasion associated with the second sidelink UE.
Aspect 4 includes the method of any of aspects 1-3, wherein at least one of a paging monitoring occasion associated with the first sidelink UE is different from a paging monitoring occasion associated with the second sidelink UE; or a WUS monitoring occasion associated with the first sidelink UE is different from a WUS monitoring occasion associated with the second sidelink UE.
Aspect 5 includes the method of any of aspects 1-4, further comprising receiving, from the second sidelink UE, a threshold value, wherein the monitoring for the at least one of the paging signal or the WUS signal is further based on a sidelink signal quality associated with the second sidelink UE satisfying the threshold value.
Aspect 6 includes the method of any of aspects 1-5, wherein the monitoring for the at least one of the paging signal or the WUS signal is further based on a radio link quality between the first sidelink UE and the BS satisfying a threshold.
Aspect 7 includes the method of any of aspects 1-6, further comprising receiving, from the second sidelink UE, at least one of an indicator indicating a paging monitoring occasion associated with the second sidelink UE; an indicator indicating a WUS monitoring occasion associated with the second sidelink UE; a threshold value associated with a sidelink signal quality; or an identifier associated with the second sidelink UE.
Aspect 8 includes the method of any of aspects 1-7, wherein the monitoring for the at least one of the paging signal or the WUS signal is further based on a power capacity associated with the first sidelink UE.
Aspect 9 includes a method of wireless communication performed by a base station (BS), the method comprising receiving, from at least one of a first sidelink UE or a second sidelink UE, a request to receive via a sidelink communication from the first sidelink UE, at least one of a paging signal associated with the second sidelink UE or a wakeup signal associated with the second sidelink UE; and transmitting, to the first sidelink UE, the at least one of the paging signal associated with the second sidelink UE or the wakeup signal associated with the second sidelink UE.
Aspect 10 includes the method of aspect 9, further comprising receiving, from the first sidelink UE, an indicator indicating identifiers of sidelink UEs that form a group of sidelink UEs, wherein the group of sidelink UEs includes the first sidelink UE and the second sidelink UE.
Aspect 11 includes the method of any of aspects 9 or 10, further comprising receiving, from the first sidelink UE, an indicator indicating a highest sidelink signal quality associated with a group of sidelink UEs, wherein the group of sidelink UEs includes the first sidelink UE and the second sidelink UE.
Aspect 12 includes method of any of aspects 9-11, further comprising transmitting to the first sidelink UE an indicator indicating a number of sidelink UEs that form a group of sidelink UEs; and receiving, from the first sidelink UE, an indicator indicating identifiers of the group of sidelink UEs, wherein the group of sidelink UEs is based on sidelink signal quality associated with the group of sidelink UEs; and the group of sidelink UEs includes the first sidelink UE and the second sidelink.
Aspect 13 includes the method of any of aspects 9-12, further comprising transmitting to the first sidelink UE a threshold value; and receiving, from the first sidelink UE, an indicator indicating identifiers associated with a group of sidelink UEs whose sidelink signal quality satisfies the threshold value, wherein the group of sidelink UEs includes the first sidelink UE and the second sidelink UE.
Aspect 14 includes the method of any of aspects 9-13, further comprising receiving, from each of a group of sidelink UEs, a request to receive at least one of a paging signal associated with each of the group of sidelink UEs or a wakeup signal associated with each of the group of sidelink UEs via a sidelink communication from the first sidelink UE, wherein the group of sidelink UEs includes the first sidelink UE and the second sidelink UE; and transmitting, to the first sidelink UE, the at least one of the paging signal associated with each of the group of sidelink UEs or the wakeup signal associated with each of the group of sidelink UEs.
Aspect 15 includes the method of any of aspects 9-14, wherein the transmitting, to the first sidelink UE, the at least one of the paging signal associated with each of the group of sidelink UEs or the wakeup signal associated with each of the group of sidelink UEs comprises transmitting, to the first sidelink UE, a bitmap indicating identifiers associated with each of the group of sidelink UEs.
Aspect 16 includes a non-transitory computer-readable medium storing one or more instructions for wireless communication, the one or more instructions comprising one or more instructions that, when executed by one or more processors of a first sidelink user equipment, cause the one or more processors to perform any one of aspects 1-8.
Aspect 17 includes a non-transitory computer-readable medium storing one or more instructions for wireless communication, the one or more instructions comprising one or more instructions that, when executed by one or more processors of a base station (BS), cause the one or more processors to perform any one of aspects 9-15.
Aspect 18 includes a first sidelink user equipment (UE) comprising one or more means to perform any one or more of aspects 1-8.
Aspect 19 includes a base station (BS) comprising one or more means to perform any one or more of aspects 9-15.
Aspect 20 includes a first sidelink user equipment (UE) comprising a memory, a transceiver and at least one processor coupled to the memory and the transceiver, wherein the first sidelink UE is configured to perform any one or more of aspects 1-8.
Aspect 20 includes a base station (BS) comprising a memory, a transceiver and at least one processor coupled to the memory and the transceiver, wherein the BS is configured to perform any one or more of aspects 9-15.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a first sidelink user equipment (UE), the method comprising:
receiving, from a second sidelink UE, a request to monitor for at least one of a paging signal associated with the second sidelink UE or a wakeup signal (WUS) associated with the second sidelink UE;
monitoring for the at least one of the paging signal or the wakeup signal based on the request;
receiving, from a base station (BS), the at least one of the paging signal or the wakeup signal; and
transmitting, to the second sidelink UE, the at least one of the paging signal or the wakeup signal.

2. The method of claim 1, wherein at least one of:
a paging monitoring occasion associated with the first sidelink UE is a same paging monitoring occasion associated with the second sidelink UE; or
a WUS monitoring occasion associated with the first sidelink UE is a same WUS monitoring occasion associated with the second sidelink UE.

3. The method of claim 1, wherein at least one of:
a paging monitoring occasion associated with the first sidelink UE overlaps a paging monitoring occasion associated with the second sidelink UE; or
a WUS monitoring occasion associated with the first sidelink UE overlaps a WUS monitoring occasion associated with the second sidelink UE.

4. The method of claim 1, wherein at least one of:
a paging monitoring occasion associated with the first sidelink UE is different from a paging monitoring occasion associated with the second sidelink UE; or
a WUS monitoring occasion associated with the first sidelink UE is different from a WUS monitoring occasion associated with the second sidelink UE.

5. The method of claim 1, further comprising:
receiving, from the second sidelink UE, a threshold value, wherein the monitoring for the at least one of the paging signal or the WUS signal is further based on a sidelink signal quality associated with the second sidelink UE satisfying the threshold value.

6. The method of claim 1, wherein the monitoring for the at least one of the paging signal or the WUS signal is further based on a radio link quality between the first sidelink UE and the BS satisfying a threshold.

7. The method of claim 1, further comprising:
receiving, from the second sidelink UE, at least one of:
an indicator indicating a paging monitoring occasion associated with the second sidelink UE;
an indicator indicating a WUS monitoring occasion associated with the second sidelink UE;
a threshold value associated with a sidelink signal quality; or
an identifier associated with the second sidelink UE.

8. The method of claim 1, wherein the monitoring for the at least one of the paging signal or the WUS signal is further based on a power capacity associated with the first sidelink UE.

9. A method of wireless communication performed by a base station (BS), the method comprising:
receiving, from at least one of a first sidelink UE or a second sidelink UE, a request to receive via a sidelink communication from the first sidelink UE, at least one of a paging signal associated with the second sidelink UE or a wakeup signal associated with the second sidelink UE; and
transmitting, to the first sidelink UE, the at least one of the paging signal associated with the second sidelink UE or the wakeup signal associated with the second sidelink UE.

10. The method of claim 9, further comprising:
receiving, from the first sidelink UE, an indicator indicating identifiers of sidelink UEs that form a group of sidelink UEs, wherein the group of sidelink UEs includes the first sidelink UE and the second sidelink UE.

11. The method of claim 9, further comprising:
receiving, from the first sidelink UE, an indicator indicating a highest sidelink signal quality associated with a group of sidelink UEs, wherein the group of sidelink UEs includes the first sidelink UE and the second sidelink UE.

12. The method of claim 9, further comprising:
transmitting to the first sidelink UE an indicator indicating a number of sidelink UEs that form a group of sidelink UEs; and
receiving, from the first sidelink UE, an indicator indicating identifiers of the group of sidelink UEs, wherein:
the group of sidelink UEs is based on sidelink signal quality associated with the group of sidelink UEs; and
the group of sidelink UEs includes the first sidelink UE and the second sidelink.

13. The method of claim 9, further comprising:
transmitting to the first sidelink UE a threshold value; and
receiving, from the first sidelink UE, an indicator indicating identifiers associated with a group of sidelink UEs whose sidelink signal quality satisfies the threshold value, wherein the group of sidelink UEs includes the first sidelink UE and the second sidelink UE.

14. The method of claim 9, further comprising:
receiving, from each of a group of sidelink UEs, a request to receive at least one of a paging signal associated with each of the group of sidelink UEs or a wakeup signal associated with each of the group of sidelink UEs via a sidelink communication from the first sidelink UE, wherein the group of sidelink UEs includes the first sidelink UE and the second sidelink UE; and
transmitting, to the first sidelink UE, the at least one of the paging signal associated with each of the group of sidelink UEs or the wakeup signal associated with each of the group of sidelink UEs.

15. The method of claim 14, wherein the transmitting, to the first sidelink UE, the at least one of the paging signal associated with each of the group of sidelink UEs or the wakeup signal associated with each of the group of sidelink UEs comprises:
transmitting, to the first sidelink UE, a bitmap indicating identifiers associated with each of the group of sidelink UEs.

16. A first sidelink user equipment (UE) comprising:
a memory;
a transceiver; and
at least one processor coupled to the memory and the transceiver, wherein the first sidelink UE is configured to:
receive, from a second sidelink UE, a request to monitor for at least one of a paging signal associated with the second sidelink UE or a wakeup signal (WUS) associated with the second sidelink UE;
monitor for the at least one of the paging signal or the wakeup signal based on the request;
receive, from a base station (BS), the at least one of the paging signal or the wakeup signal; and
transmit, to the second sidelink UE, the at least one of the paging signal or the wakeup signal.

17. The method of claim 16, wherein at least one of:
a paging monitoring occasion associated with the first sidelink UE is a same paging monitoring occasion associated with the second sidelink UE; or
a WUS monitoring occasion associated with the first sidelink UE is a same WUS monitoring occasion associated with the second sidelink UE.

18. The first sidelink UE of claim 16, wherein at least one of:
a paging monitoring occasion associated with the first sidelink UE overlaps a paging monitoring occasion associated with the second sidelink UE; or
a WUS monitoring occasion associated with the first sidelink UE overlaps a WUS monitoring occasion associated with the second sidelink UE.

19. The first sidelink UE of claim 16, wherein at least one of:
a paging monitoring occasion associated with the first sidelink UE is different from a paging monitoring occasion associated with the second sidelink UE; or
a WUS monitoring occasion associated with the first sidelink UE is different from a WUS monitoring occasion associated with the second sidelink UE.

20. The first sidelink UE of claim 16, wherein the first sidelink UE is further configured to:
receive, from the second sidelink UE, a threshold value, wherein the monitoring for the at least one of the paging signal or the WUS signal is further based on a sidelink signal quality associated with the second sidelink UE satisfying the threshold value.

21. The first sidelink UE of claim 16, wherein the monitoring for the at least one of the paging signal or the WUS signal is further based on a radio link quality between the first sidelink UE and the BS satisfying a threshold.

22. The first sidelink UE of claim 16 wherein the first sidelink UE is further configured to:
receive, from the second sidelink UE, at least one of:
an indicator indicating a paging monitoring occasion associated with the second sidelink UE;
an indicator indicating a WUS monitoring occasion associated with the second sidelink UE;
a threshold value associated with a sidelink signal quality; or
an identifier associated with the second sidelink UE.

23. The first sidelink UE of claim 16, wherein the monitoring for the at least one of the paging signal or the WUS signal is further based on a power capacity associated with the first sidelink UE.

24. A base station (BS) comprising:
a memory;
a transceiver; and
at least one processor coupled to the memory and the transceiver, wherein the BS is configured to:
receive, from at least one of a first sidelink UE or a second sidelink UE, a request to receive via a sidelink communication from the first sidelink UE, at least one of a paging signal associated with the second sidelink UE or a wakeup signal associated with the second sidelink UE; and
transmit, to the first sidelink UE, the at least one of the paging signal associated with the second sidelink UE or the wakeup signal associated with the second sidelink UE.

25. The BS of claim 24, wherein the BS is further configured to:
receive, from the first sidelink UE, an indicator indicating identifiers of sidelink UEs that form a group of sidelink UEs, wherein the group of sidelink UEs includes the first sidelink UE and the second sidelink UE.

26. The BS of claim 24, wherein the BS is further configured to:
receive, from the first sidelink UE, an indicator indicating a highest sidelink signal quality associated with a group of sidelink UEs, wherein the group of sidelink UEs includes the first sidelink UE and the second sidelink UE.

27. The BS of claim 24, wherein the BS is further configured to:
transmit to the first sidelink UE an indicator indicating a number of sidelink UEs that form a group of sidelink UEs; and
receive, from the first sidelink UE, an indicator indicating identifiers of the group of sidelink UEs, wherein:
the group of sidelink UEs is based on sidelink signal quality associated with the group of sidelink UEs; and
the group of sidelink UEs includes the first sidelink UE and the second sidelink.

28. The BS of claim 24, wherein the BS is further configured to:
transmit to the first sidelink UE a threshold value; and
receive, from the first sidelink UE, an indicator indicating identifiers associated with a group of sidelink UEs whose sidelink signal quality satisfies the threshold value, wherein the group of sidelink UEs includes the first sidelink UE and the second sidelink UE.

29. The BS of claim 24, wherein the BS is further configured to:
receive, from each of a group of sidelink UEs, a request to receive at least one of a paging signal associated with each of the group of sidelink UEs or a wakeup signal associated with each of the group of sidelink UEs via a sidelink communication from the first sidelink UE, wherein the group of sidelink UEs includes the first sidelink UE and the second sidelink UE; and
transmit, to the first sidelink UE, the at least one of the paging signal associated with each of the group of sidelink UEs or the wakeup signal associated with each of the group of sidelink UEs.

30. The BS of claim 29, wherein the BS is further configured to:
transmit, to the first sidelink UE, a bitmap indicating identifiers associated with each of the group of sidelink UEs.
